(19) United States
(12) Patent Application Publication
(10) Pub. No.: US 2026/0032202 A1
(43) Pub. Date: Jan. 29, 2026

(54) CONTROL DEVICE AND SYSTEM PROMPTING WARRANTY CONTRACT EXECUTION BASED ON LIFETIME CONDITIONS RELATED TO THE CONTROL DEVICE

(71) Applicant: BROTHER KOGYO KABUSHIKI KAISHA, Nagoya (JP)

(72) Inventor: Yuka ISHIHARA, Nagoya (JP)

(73) Assignee: BROTHER KOGYO KABUSHIKI KAISHA, Nagoya (JP)

(21) Appl. No.: 19/272,265

(22) Filed: Jul. 17, 2025

(30) Foreign Application Priority Data
Jul. 23, 2024 (JP) 2024-117473
Feb. 27, 2025 (JP) 2025-029858

(51) Int. Cl. H04N 1/00; H04N 1/34

(52) U.S. Cl. CPC H04N 1/00408; H04N 1/00037; H04N 1/00076; H04N 1/348

(57) ABSTRACT

A control device includes a display and a controller. The controller is configured to cause the display to display a first object for prompting execution of a warranty contract under which another control device is provided in response to a failure of the control device, when a particular condition related to a lifetime of the control device is satisfied.

### REFERENCE TO RELATED APPLICATIONS

This application claims priority from Japanese Patent Applications No. 2024-117473, filed on Jul. 23, 2024, and No. 2025-029858, filed on Feb. 27, 2025. The entire contents of the priority applications are incorporated herein by reference.

### BACKGROUND ART

As an example of a control device, an image forming apparatus configured to perform image printing under a contract form referred to as a “metered contract” has been known. Under the metered contract, a user pays a monthly maintenance service fee that includes a fixed monthly fee and an additional usage-based fee depending on the number of printed pages or sheets each month, while supply items are provided free of charge or nearly free of charge. Furthermore, in the known image forming apparatus, the contract may be switched in conjunction with a firmware update.

### SUMMARY

Here, when a control device is operating normally, a user is often not highly motivated to enter into a warranty contract such as the aforementioned contract.

Aspects of the present disclosure are advantageous in providing one or more improved techniques for a control device and a system configured to prompt a user to enter into a warranty contract when the user is highly motivated to enter into the warranty contract.

According to aspects of the present disclosure, a control device is provided, which includes a display and a controller. The controller is configured to cause the display to display a first object for prompting execution of a warranty contract under which another control device is provided in response to a failure of the control device, when a particular condition related to a lifetime of the control device is satisfied.

According to aspects of the present disclosure, further provided is a control device that includes a communication interface and a controller. The communication interface is configured to communicably connect to an external device including a display. The controller is configured to cause the display of the external device to display an object for prompting execution of a warranty contract under which another control device is provided in response to a failure of the control device, when a particular condition related to a lifetime of the control device is satisfied, while the control device is communicable with the external device via the communication interface.

According to aspects of the present disclosure, further provided is a system that includes a control device, an information processing device, and a server. The information processing device includes a display. The information processing device is communicably connected to the control device. The server is communicably connected to the control device. The server includes a controller. The controller is configured to acquire lifetime information regarding a lifetime of the control device. The controller is further configured to, when the acquired lifetime information indicates that a particular condition related to the lifetime of the control device is satisfied, cause the display of the information processing device to display an object for prompting execution of a warranty contract under which another control device is provided in response to a failure of the control device.

According to aspects of the present disclosure, further provided is a system that includes a control device and an information processing device. The control device includes a display, a memory, and a first controller. The information processing device is communicably connected to the control device. The information processing device includes a second controller. The second controller is configured to acquire device information regarding the control device. The second controller is further configured to estimate a remaining lifetime of the control device based on the acquired device information. The second controller is further configured to transmit, to the control device, lifetime information regarding the estimated remaining lifetime of the control device. The first controller of the control device is configured to receive the lifetime information from the information processing device and store the received lifetime information in the memory. The first controller is further configured to, in a state where the control device is communicable with the information processing device, cause the display to display an object for prompting execution of a warranty contract under which another control device is provided in response to a failure of the control device, when a first condition related to the remaining lifetime indicated by the lifetime information received from the information processing device is satisfied. The first controller is further configured to, in a state where the control device is not communicable with the information processing device, cause the display to display the object, when a second condition related to the remaining lifetime indicated by the lifetime information stored in the memory is satisfied.

### BRIEF DESCRIPTION OF DRAWINGS

FIG. 1 schematically shows a configuration of a printer.

FIG. 2 is a block diagram showing an electrical configuration of a system including the printer.

FIG. 3 is a flowchart showing a processing procedure for prompting execution of a warranty contract based on the remaining lifetime of the printer.

FIG. 4A is a flowchart showing a procedure of a display process.

FIG. 4B is a sequence diagram showing a signal transmission and reception procedure performed between the printer and a server to execute the warranty contract.

FIG. 5A shows an example of a contract guidance screen when the remaining lifetime of the printer is short.

FIG. 5B shows an example of a contract selection screen.

FIG. 5C shows an example of a warranty notification screen when the remaining lifetime of the printer is short.

FIG. 5D shows an example of a purchase guidance screen when the remaining lifetime of the printer is short.

FIG. 6A shows an example of a contract guidance screen when the printer has failed.

FIG. 6B shows an example of a warranty notification screen when the printer has failed.

FIG. 6C shows an example of a purchase guidance screen when the printer has failed.

FIG. 7 is a flowchart showing a processing procedure for prompting execution of a warranty contract based on the remaining lifetime of a replacement component.

FIG. 8A shows an example of a contract guidance screen when the remaining lifetime of the replacement component is short.

FIG. 8B shows an example of a contract selection screen.

FIG. 8C shows an example of a warranty notification screen when the remaining lifetime of the replacement component is short.

FIG. 8D shows an example of a purchase guidance screen when the remaining lifetime of the replacement component is short.

FIG. 9A shows an example of a contract guidance screen when the replacement component has failed.

FIG. 9B shows an example of a warranty notification screen when the replacement component has failed.

FIG. 9C shows an example of a purchase guidance screen when the replacement component has failed.

FIG. 10 is a flowchart showing a processing procedure for displaying a notification on a message bar when the remaining lifetime of the printer is short, and for displaying a contract guidance screen as a popup when the printer has failed.

FIG. 11 is a flowchart showing a processing procedure for displaying a notification on a message bar when the remaining lifetime of the replacement component is short, and for displaying a contract guidance screen as a popup when the replacement component has failed.

FIG. 12A shows an example in which a message is displayed on the message bar to notify that the remaining lifetime of the printer is short.

FIG. 12B shows an example in which a contract guidance screen is displayed as a popup when the printer has failed.

FIG. 12C shows an example in which a message is displayed on the message bar to notify that the remaining lifetime of the replacement component is short.

FIG. 12D shows an example in which a contract guidance screen is displayed as a popup when the replacement component has failed.

FIG. 13 is a block diagram showing an electrical configuration of a system including the printer, a server, and an external device.

FIG. 14 is a flowchart showing a processing procedure for causing a display of the external device to display a contract guidance screen and other screens under the control of the server based on the remaining lifetime of the printer.

FIG. 15 is a flowchart showing a processing procedure for causing the display of the external device to display a contract guidance screen and other screens under the control of the server based on the remaining lifetime of the replacement component.

FIG. 16A is a sequence diagram showing a processing procedure for transmitting and receiving device information and lifetime information between the printer and the server.

FIG. 16B is a flowchart showing a processing procedure for displaying a contract guidance screen and other screens based on the remaining lifetime of the printer, regardless of whether the printer and the server are communicable with each other.

### DESCRIPTION

It is noted that various connections are described between elements in the following description. These connections, unless specified otherwise, may be either direct or indirect, and this specification is not intended to be limiting in that respect. Aspects of the present disclosure may be implemented using circuits (such as application-specific integrated circuits) or computer software stored on computer-readable media, including but not limited to RAMs, ROMs, flash memories, EEPROMs, CD media, DVD media, temporary storage, hard disk drives, floppy drives, permanent storage, and the like.

As used herein, the term “processor” encompasses a single processor or a group of multiple processors, which may include a single-core processor, a multi-core processor, multiple processors within a single device, or multiple processors in wired or wireless communication with each other. Such processors may be locally or remotely distributed and may operate collaboratively or in a distributed fashion across a network of devices, the Internet, or the cloud to collectively perform the tasks attributed to the “processor” described herein. Similarly, the term “non-transitory computer-readable storage medium” encompasses a single storage medium or a group of multiple storage media, which may be locally or remotely distributed and may collectively store and provide access to instructions, data, or other information in a coordinated or distributed manner.

In the present disclosure, an inclusive OR—meaning that it includes either A, B, or both—may be expressed as “A and/or B,” “at least one of A or B,” or “at least one selected from the group consisting of A and B.” Additionally, the expression “one of A or B,” as used herein, refers to a case where A or B is selected exclusively, but not both. The same interpretation applies in cases where three or more selectable elements are considered.

### First Illustrative Embodiment

The following describes a first illustrative embodiment according to aspects of the present disclosure.

### Overall Configuration of Printer

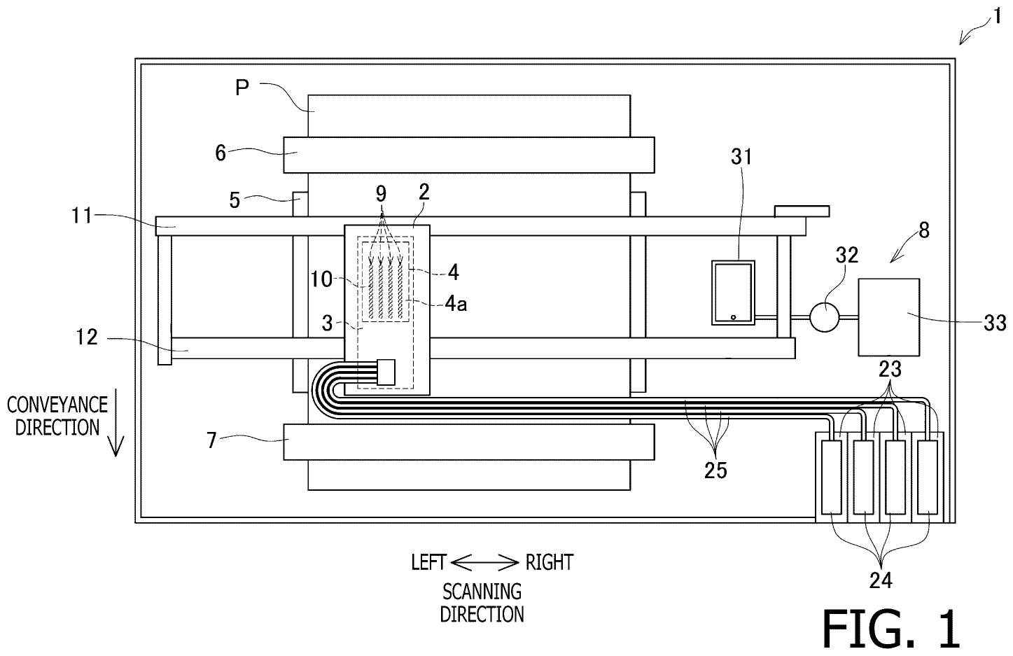

As shown in FIG. 1, a printer 1 in the first illustrative embodiment includes a carriage 2, sub-tanks 3, an inkjet head 4, a platen 5, conveyance rollers 6 and 7, and a maintenance unit 8. In the first illustrative embodiment, the printer 1 may be an example of a “control device” according to aspects of the present disclosure, and may be an example of an “image recording apparatus” according to aspects of the present disclosure.

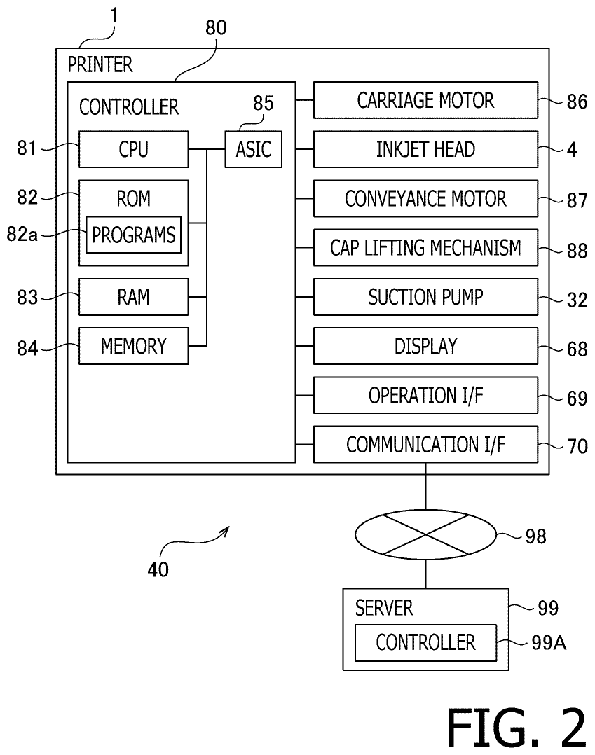

The carriage 2 is supported by two guide rails 11 and 12 extending in a scanning direction. The carriage 2 is connected to a carriage motor 86 shown in FIG. 2, for instance, via a belt (not shown). The carriage 2 is configured to move along the guide rails 11 and 12 in the scanning direction when the carriage motor 86 is driven. It is noted that the following description will be provided with a right side and a left side defined in the scanning direction, as illustrated in FIG. 1.

The sub-tanks 3 are mounted on the carriage 2. The printer 1 includes four cartridge holders 23 arranged in the scanning direction at a right end portion in the scanning direction and at a downstream end portion in a conveyance direction that extends horizontally and is orthogonal to the scanning direction. An ink cartridge 24 is removably mounted in each cartridge holder 23. Black, yellow, cyan, and magenta inks are stored in the four ink cartridges 24, respectively, in this order from the rightmost cartridge holder 23 in the scanning direction. The four ink cartridges 24 are connected to the sub-tanks 3 via four tubes 25, and the inks are supplied to the sub-tanks 3 through the tubes 25.

The inkjet head 4 is mounted on the carriage 2 and attached to lower surfaces of the sub-tanks 3. The inkjet head 4 is supplied with the four-color inks from the sub-tanks 3. The inkjet head 4 is configured to eject ink from a plurality of nozzles 10 formed on a nozzle surface 4a, which is a lower surface of the inkjet head 4. More specifically, the plurality of nozzles 10 are arranged in the conveyance direction to form four nozzle rows 9, each of which extends in the conveyance direction. The four nozzle rows 9 are arranged side by side along the scanning direction on the nozzle surface 4a. The plurality of nozzles 10 are configured to eject black, yellow, cyan, and magenta inks from the four nozzle rows 9, respectively, in this order from the rightmost nozzle row 9 in the scanning direction.

The platen 5 is disposed below the inkjet head 4 and positioned to face the plurality of nozzles 10. The platen 5 extends over an entire width of a recording sheet S in the scanning direction, and is configured to support the recording sheet S from below. The conveyance roller 6 is disposed upstream of the inkjet head 4 and the platen 5 in the conveyance direction. The conveyance roller 7 is disposed downstream of the inkjet head 4 and the platen 5 in the conveyance direction. The conveyance rollers 6 and 7 have axial directions extending along the scanning direction, and are connected to a conveyance motor 87 shown in FIG. 2, for instance, via gears (not shown). The conveyance rollers 6 and 7 are configured to rotate when the conveyance motor 87 is driven, thereby conveying the recording sheet S in the conveyance direction.

The maintenance unit 8 includes a cap 31, a suction pump 32, and a waste liquid tank 33. The cap 31 is disposed to the right of the platen 5 in the scanning direction. When the carriage 2 is at a maintenance position to the right of the platen 5 in the scanning direction, the plurality of nozzles 10 face the cap 31.

The cap 31 is connected to a cap lifting mechanism 88 shown in FIG. 2. The cap 31 is configured to move up and down when the cap lifting mechanism 88 is driven. When the carriage 2 is located at the maintenance position and the plurality of nozzles 10 are positioned to face the cap 31, an upper end portion of the cap 31 comes into close contact with the nozzle surface 4a as the cap 31 is lifted by the cap lifting mechanism 88. As a result, the plurality of nozzles 10 are brought into a capped state where they are covered by the cap 31. When the cap 31 is lowered, the plurality of nozzles 10 are not covered by the cap 31. It is noted that the cap 31 is not necessarily configured to cover the plurality of nozzles 10 by coming into close contact with the nozzle surface 4a. For instance, the cap 31 may be configured to cover the plurality of nozzles 10 by coming into close contact with a frame (not shown) disposed around the nozzle surface 4a of the inkjet head 4.

The suction pump 32 is, for instance, a tube pump, and is connected to the cap 31 and the waste liquid tank 33. In the maintenance unit 8, when the suction pump 32 is driven while the plurality of nozzles 10 are in the capped state, ink inside the inkjet head 4 is ejected from the plurality of nozzles 10, thereby performing so-called suction purging. The ink ejected by the suction purging is stored in the waste liquid tank 33.

For the sake of explanatory convenience, the above description has been provided under an assumption that the cap 31 collectively covers all of the nozzles 10 and that ink is ejected from all of the nozzles 10 during the suction purging. However, the feasible configurations according to aspects of the present disclosure are not limited thereto. For instance, the cap 31 may separately include a portion configured to cover a plurality of nozzles 10 forming the rightmost nozzle row 9 for ejecting black ink, and a portion configured to cover a plurality of nozzles 10 forming the remaining three nozzle rows 9 for ejecting color inks. In this case, either the black ink or the color inks inside the inkjet head 4 may be selectively ejected during the suction purging. Here, the color inks refer to yellow, cyan, and magenta inks. In another instance, a separate cap may be provided for each nozzle row 9, thereby allowing ink to be ejected individually from each nozzle row 9 during the suction purging.

### Electrical Configuration of Printer

Next, an electrical configuration of the printer 1 will be described. As shown in FIG. 2, the printer 1 includes a controller 80. The controller 80 includes a CPU 81, a ROM 82, a RAM 83, a memory 84, and an ASIC 85. It is noted that “CPU,” “ROM,” “RAM,” and “ASIC” stand for “Central Processing Unit,” “Read Only Memory,” “Random Access Memory,” and “Application Specific Integrated Circuit,” respectively. The controller 80 is configured to control the carriage motor 86, the inkjet head 4, the conveyance motor 87, the cap lifting mechanism 88, and the suction pump 32.

In addition to the aforementioned configuration, the printer 1 further includes a display 68, an operation I/F 69, and a communication I/F 70. The display 68 is, for instance, a liquid crystal display (hereinafter, simply referred to as “LCD”). The display 68 is configured to display thereon various screens under the control of the controller 80. The operation I/F 69 includes, for instance, hard keys and a touch panel provided on the display 68. The operation I/F 69 is configured to output, when operated by a user, a signal corresponding to the user's operation to the controller 80.

The communication I/F 70 is connected to a network 98 such as the Internet, and is configured to communicate with a server 99 via the network 98. The communication I/F 70 may be connected to the network 98 through either a wired or wireless connection. The controller 80 is configured to perform signal communication with the server 99 via the communication I/F 70 and the network 98. In the first illustrative embodiment, the printer 1 and the server 99, which are interconnected via the network 98, form a system 40.

The controller 80 may be configured to perform various types of processing by only the CPU 81, only the ASIC 85, or through cooperation between the CPU 81 and the ASIC 85. Further, the controller 80 may perform the processing using a single CPU 81 or multiple CPUs 81 that share the processing. Likewise, the controller 80 may perform the processing using a single ASIC 85 or multiple ASICs 85 that share the processing. If the controller 80 is configured to perform various types of processing by the CPU 81, the CPU 81 may be configured to execute programs 82a stored in the ROM 82, thereby performing the processing in accordance with the flowcharts to be described below.

### Control During Recording

Next, an explanation is provided of processing executed by the controller 80 when the printer 1 performs image recording on a recording sheet S. In response to receiving a recording instruction to record an image onto the recording sheet S, the controller 80 causes the printer 1 to perform the image recording by repeatedly and alternately executing recording passes and conveyance operations. Specifically, in each recording pass, the controller 80 controls the inkjet head 4 to eject ink from the plurality of nozzles 10 toward the recording sheet S, while controlling the carriage motor 86 to move the carriage 2 along the scanning direction. Further, in each conveyance operation, the controller 80 controls the conveyance motor 87 to drive the conveyance rollers 6 and 7, thereby conveying the recording sheet S in the conveyance direction by a predetermined distance.

For instance, the controller 80 may receive the recording instruction when an operation to initiate the image recording is performed via the operation I/F 69 of the printer 1. In another instance, the controller 80 may receive the recording instruction when the printer 1 is connected to an external device (not shown), such as a PC or a smartphone, and an operation to initiate the image recording is performed via the external device.

### Processing for Prompting Warranty Contract Execution

Next, an explanation is provided of processing for prompting the user to enter into a warranty contract based on a remaining lifetime of the printer 1. Here, the warranty contract refers to a subscription contract under which warranty coverage is continued by paying a particular fee for each particular period. The particular fee may be a fixed fee or a variable fee that changes depending on each particular period. In the first illustrative embodiment, the warranty contract includes a warranty that provides coverage under which another printer 1 (i.e., a replacement printer 1) is provided free of charge if the printer 1 fails.

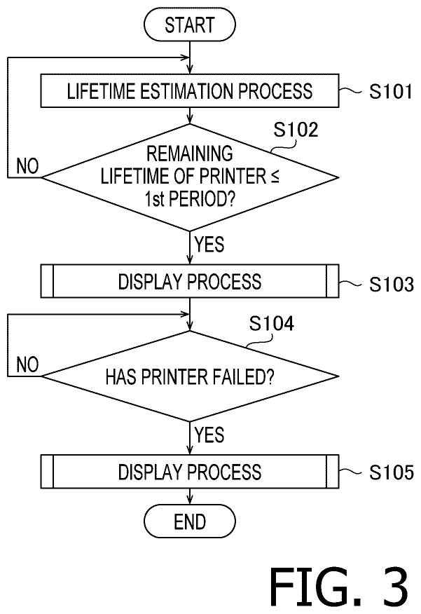

In the printer 1, the controller 80 performs processing in accordance with the flowchart illustrated in FIG. 3, thereby prompting the user to enter into a warranty contract based on the remaining lifetime of the printer 1. For instance, the controller 80 may start the processing in accordance with the flowchart of FIG. 3 when power is first supplied to the printer 1.

The flowchart in FIG. 3 will be described in detail below. The controller 80 performs a lifetime estimation process (S101). In this process, the controller 80 estimates the remaining lifetime of the printer 1 based on, for instance, signals from sensors (not shown) of the printer 1, the elapsed time since the printer 1 was first activated, and the total number of recorded pages.

Subsequently, the controller 80 determines whether the remaining lifetime of the printer 1 estimated in S101 is equal to or less than a first period (S102). The first period may be defined, for instance, as a period of time such as “remaining xx days,” or as a ratio such as “remaining one-third” or “remaining 20%” of the total lifetime. Other periods to be described later, such as a second period, may be defined in a similar manner.

In response to determining that the remaining lifetime of the printer 1 is longer than the first period (S102: NO), the controller 80 returns to S101. In response to determining that the remaining lifetime of the printer 1 is equal to or less than the first period (S102: YES), the controller 80 proceeds to S103 to perform a display process.

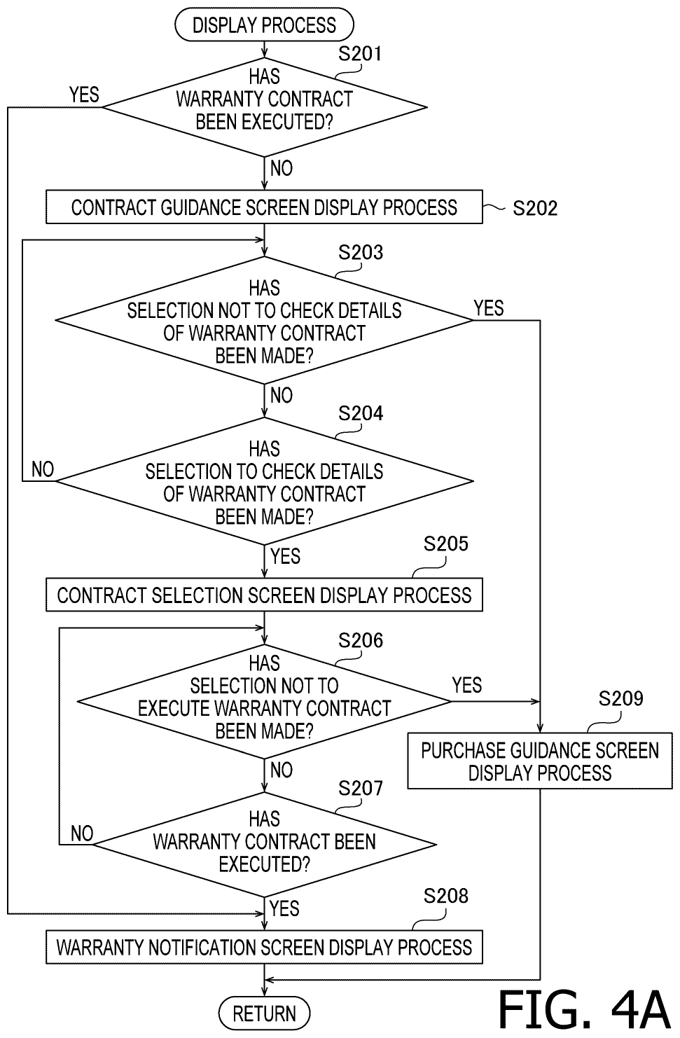

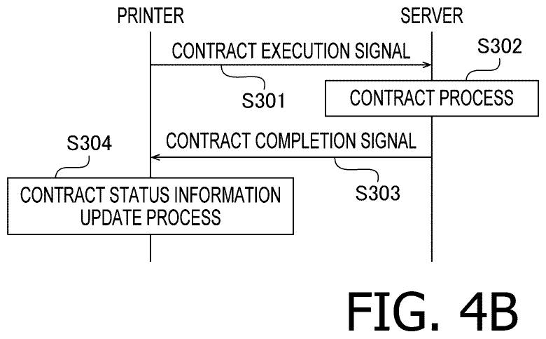

In the display process of S103, the controller 80 performs processing in accordance with the flowchart illustrated in FIG. 4A. Specifically, in this process, the controller 80 first determines whether a warranty contract has been executed (S201).

The execution of a warranty contract is described below. For instance, when an operation to execute the warranty contract has been performed via the operation I/F 69 of the printer 1, as shown in FIG. 4B, the printer 1 transmits a contract execution signal to the server 99 (S301). The contract execution signal indicates that the warranty contract is to be executed. In response to receiving the contract execution signal from the printer 1, a controller 99A of the server 99 performs a contract process for executing the warranty contract (S302). The contract process of S302 includes, for instance, storing in the server 99 information such as a subscriber of the warranty contract and a management number of the contract. The controller 99A of the server 99 includes a CPU, a ROM, a RAM, and a memory.

After the contract process is completed, the server 99 transmits a contract completion signal to the printer 1 (S303). In response to receiving the contract completion signal from the server 99, the controller 80 of the printer 1 performs a contract status information update process (S304). In this case, the memory 84 of the printer 1 stores contract status information indicating whether the warranty contract has been executed. In the contract status information update process of S304, the controller 80 updates the contract status information stored in the memory 84 from indicating that the warranty contract has not been executed to indicating that the warranty contract has been executed.

In S201, the controller 80 acquires the contract status information stored in the memory 84 and determines, based on the acquired contract status information, whether the warranty contract has been executed.

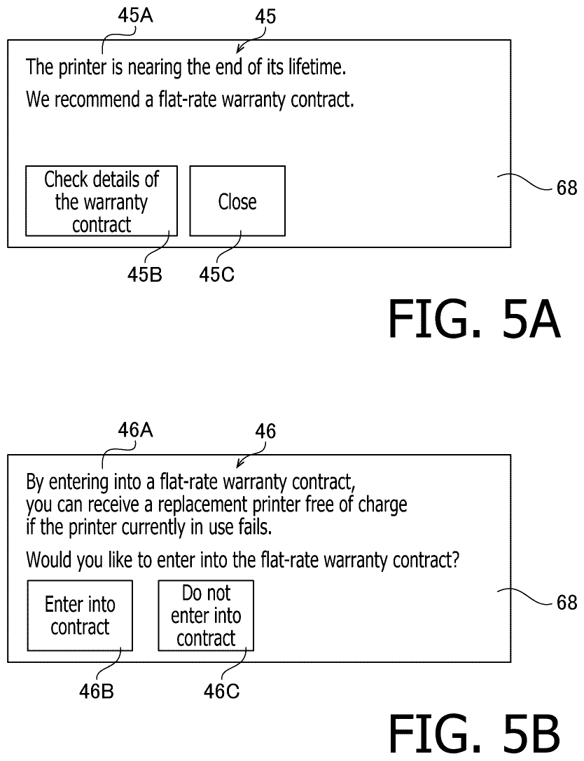

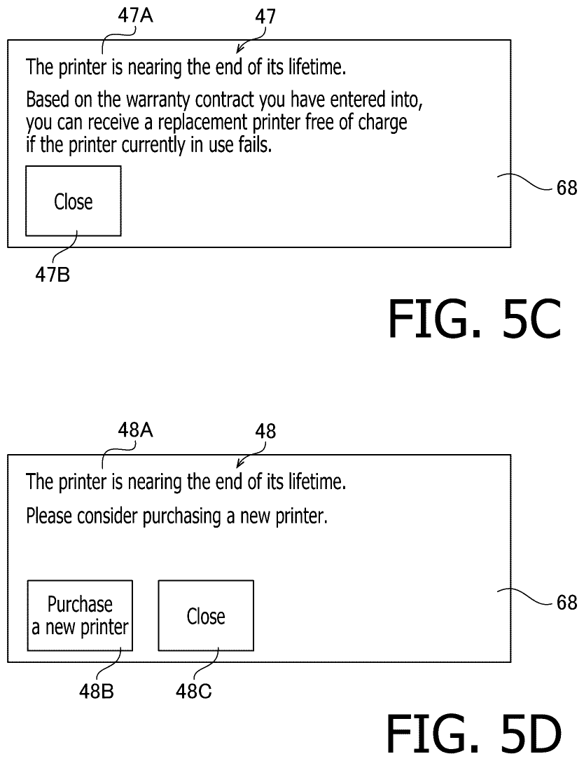

In response to determining that the warranty contract has been executed (S201: YES), the controller 80 proceeds to S208. In response to determining that the warranty contract has not been executed (S201: NO), the controller 80 proceeds to S202 to perform a contract guidance screen display process. In this process, the controller 80 displays, for instance, a contract guidance screen 45 as shown in FIG. 5A on the display 68.

Accordingly, in the first illustrative embodiment, when the contract status information indicates that the warranty contract has not been executed—namely, when the printer 1 has not received the contract completion signal—and the remaining lifetime of the printer 1 is equal to or less than the first period, the contract guidance screen 45 is displayed on the display 68. On the other hand, after the printer 1 has received the contract completion signal, the contract status information indicates that the warranty contract has been executed. In that case, as described above, the controller 80 determines in S201 that the warranty contract has been executed (S201: YES) and proceeds to S208. Thus, in the first illustrative embodiment, after the printer 1 has received the contract completion signal, the contract guidance screen 45 is not displayed on the display 68, even when the remaining lifetime of the printer 1 is equal to or less than the first period.

The contract guidance screen 45 illustrated in FIG. 5A includes a message section 45A and selection sections 45B and 45C. The message section 45A displays a message notifying the user that the printer 1 is nearing the end of its lifetime, and a message prompting the user to enter into the warranty contract. The selection section 45B is selected when the user wishes to check the details of the warranty contract. The selection section 45C is selected when the user does not wish to check the details of the warranty contract.

When the operation I/F 69 includes a touch panel provided on the display 68, the selection sections 45B and 45C may be selected by touching corresponding areas on the display 68. When the operation I/F 69 includes a set of hard keys, the selection sections 45B and 45C may be selected by operating corresponding hard keys. The same applies to other selection sections to be described later.

Referring back to FIG. 4A, after the contract guidance screen display process of S202, the controller 80 waits until either a selection not to check the details of the warranty contract or a selection to check the details thereof is made (S203: NO, S204: NO). In other words, the controller 80 waits until one of the selection sections 45B and 45C is selected.

In response to determining that the selection section 45C has been selected—that is, the selection not to check the details of the warranty contract has been made (S203: YES)—the controller 80 proceeds to S209. In response to determining that the selection section 45B has been selected—that is, the selection to check the details of the warranty contract has been made (S204: YES)—the controller 80 proceeds to S205 to perform a contract selection screen display process. In this process, the controller 80 displays, for instance, a contract selection screen 46 as illustrated in FIG. 5B on the display 68.

The contract selection screen 46 shown in FIG. 5B includes a message section 46A and selection sections 46B and 46C. The message section 46A displays a message informing the user that executing the warranty contract allows the user to receive a replacement printer 1 free of charge if the printer 1 fails, and a message inquiring whether the user wishes to enter into the warranty contract. The selection section 46B is selected when the user wishes to enter into the warranty contract. The selection section 46C is selected when the user does not wish to enter into the warranty contract.

When the selection section 46B has been selected, signal communication is performed between the printer 1 and the server 99, as shown in FIG. 4B, in substantially the same manner as previously described, and the warranty contract is executed. After the execution of the warranty contract is completed, the server 99 transmits the contract completion signal to the printer 1, and the contract status information stored in the memory 84 of the printer 1 is updated from indicating that the warranty contract has not been executed to indicating that the warranty contract has been executed.

Referring back to FIG. 4A, after the contract selection screen display process of S205, the controller 80 waits until either a selection not to execute the warranty contract is made or the execution of the warranty contract is completed (S206: NO, S207: NO). In other words, the controller 80 waits until the selection section 46C is selected, or until the execution of the warranty contract is completed after the processing of S301 to S304 has been performed in response to the selection of the selection section 46B.

In response to determining that the selection section 46C has been selected—indicating that the user does not wish to enter into the warranty contract (S206: YES)—the controller 80 proceeds to S209. If the execution of the warranty contract is completed (S207: YES) after the processing of S301 to S304 has been performed in response to the selection of the selection section 46B, the controller 80 proceeds to S208.

In S208, the controller 80 performs a warranty notification screen display process. In this process, the controller 80 displays, for instance, a warranty notification screen 47 as illustrated in FIG. 5C on the display 68.

The warranty notification screen 47 shown in FIG. 5C includes a message section 47A and a selection section 47B. The message section 47A displays a message indicating that the printer 1 is nearing the end of its lifetime, and that, based on the warranty contract, the user is allowed to receive a replacement printer 1 free of charge if the printer 1 fails. The selection section 47B is selected when the user wishes to close the warranty notification screen 47. When the selection section 47B is selected, the warranty notification screen 47 displayed on the display 68 is closed.

In S209, the controller 80 performs a purchase guidance screen display process. In this process, the controller 80 displays, for instance, a purchase guidance screen 48 as illustrated in FIG. 5D on the display 68.

The purchase guidance screen 48 shown in FIG. 5D includes a message section 48A and selection sections 48B and 48C. The message section 48A displays a message notifying the user that the printer 1 is nearing the end of its lifetime, and a message prompting the user to purchase a replacement printer 1.

The selection section 48B is selected when the user wishes to purchase another printer. When the selection section 48B is selected, for instance, a purchase screen (not shown) for purchasing another printer may be displayed on the display 68. Thus, the user is allowed to purchase another printer via the purchase screen. The selection section 48C is selected when the user wishes to close the purchase guidance screen 48. When the selection section 48C is selected, the purchase guidance screen 48 displayed on the display 68 is closed.

After completing either S208 or S209, the controller 80 terminates the display process of S103 and then returns to the flowchart of FIG. 3. After the display process of S103, the controller 80 determines whether the printer 1 has failed (S104). The controller 80 may make the determination in S104 based on, for instance, signals from sensors (not shown) of the printer 1.

After the display process of S103, the controller 80 waits until the printer 1 fails (S104: NO). Accordingly, after the contract guidance screen 45 is displayed once on the display 68 in S202 in the display process of S103, the contract guidance screen 45 is not displayed again on the display 68 until the printer 1 fails.

In response to determining that the printer 1 has failed (S104: YES), the controller 80 proceeds to S105 to perform a display process. Thereafter, the controller 80 terminates the process illustrated in FIG. 3. In substantially the same manner as in the display process of S103, the controller 80 performs the display process of S105 in accordance with the flowchart illustrated in FIG. 4A.

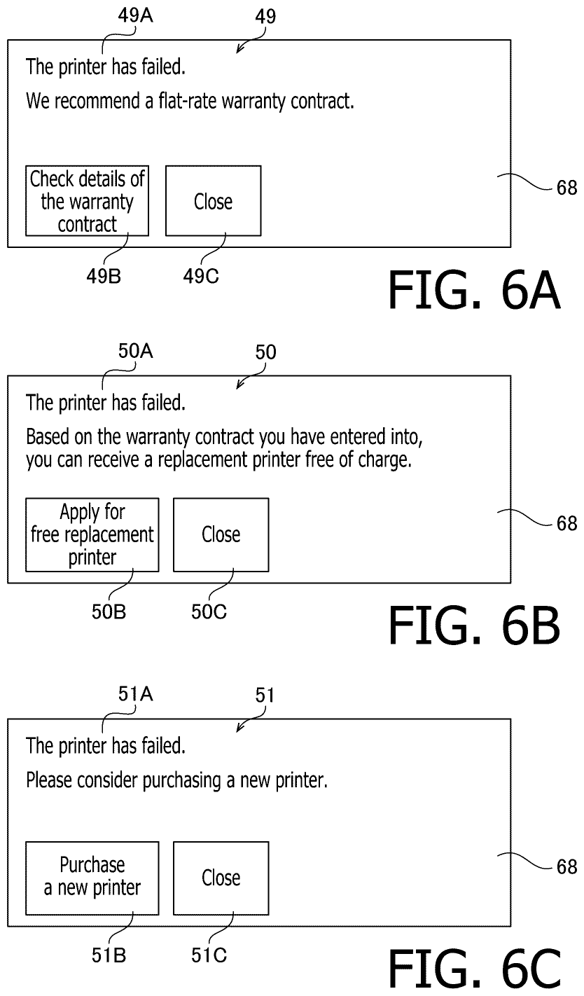

In the display process of S105, the controller 80 displays, for instance, a contract guidance screen 49 as illustrated in FIG. 6A on the display 68, in the contract guidance screen display process of S202. Accordingly, in the first illustrative embodiment, when the printer 1 has failed without receiving the contract completion signal, the contract guidance screen 49 is displayed on the display 68. On the other hand, in substantially the same manner as in the display process of S103, in the display process of S105 as well, after the printer 1 has received the contract completion signal, the contract guidance screen 49 is not displayed on the display 68 even if the printer 1 fails.

The contract guidance screen 49 shown in FIG. 6A includes a message section 49A and selection sections 49B and 49C. The message section 49A displays a message notifying the user that the printer 1 has failed, and a message prompting the user to enter into the warranty contract. The selection sections 49B and 49C are configured in substantially the same manner as the selection sections 45B and 45C on the contract guidance screen 45, respectively.

In the display process of S105, the controller 80 displays, for instance, a warranty notification screen 50 as illustrated in FIG. 6B on the display 68, in the warranty notification screen display process of S208. The warranty notification screen 50 shown in FIG. 6B includes a message section 50A and selection sections 50B and 50C. The message section 50A displays a message informing the user that the printer 1 has failed and that the user is allowed to receive a replacement printer free of charge based on the warranty contract. The selection section 50B is operated to apply for the free replacement of the printer 1 with another printer based on the warranty contract. When the selection section 50B is selected, for instance, an application screen (not shown) for applying for the free replacement of the printer 1 is displayed on the display 68. The user is allowed to apply for the free replacement of the printer 1 via the application screen. The selection section 50C is configured in substantially the same manner as the selection section 47B on the warranty notification screen 47.

In the display process of S105, the controller 80 also displays, for instance, a purchase guidance screen 51 as illustrated in FIG. 6C on the display 68, in the purchase guidance screen display process of S209. The purchase guidance screen 51 shown in FIG. 6C includes a message section 51A and selection sections 51B and 51C. The message section 51A displays a message notifying the user that the printer 1 has failed, and a message prompting the user to purchase a replacement printer. The selection sections 51B and 51C are configured in substantially the same manner as the selection sections 48B and 48C on the purchase guidance screen 48, respectively.

In the first illustrative embodiment, the following conditions may be included among examples of a “particular condition” according to aspects of the present disclosure—(1) where the remaining lifetime of the printer 1 is equal to or less than the first period, and (2) where the printer 1 has failed.

### Advantageous Effects

In the first illustrative embodiment, when the remaining lifetime of the printer 1 is equal to or less than the first period, the contract guidance screen 45 is displayed on the display 68. As a result, when the remaining lifetime of the printer 1 is short and the user's willingness to enter into the warranty contract is relatively high, the printer 1, configured as described above, is enabled to prompt the user to enter into the warranty contract. Here, the “lifetime” of the printer 1 refers to an estimated usage period until the printer 1 fails or becomes unusable if it is not repaired, maintained, or replenished. Specifically, the lifetime of the printer 1 may be, for instance, an estimated usage period of five years. In another instance, the lifetime of the printer 1 may be the average value, the minimum value, or the maximum value of actual usage periods until the failures of five printers 1 in the past. In yet another instance, the lifetime of the printer 1 may represent a remaining amount (e.g., 100 available recording sheets) of a consumable item usable by the printer 1, or a remaining number (e.g., 100 available recording operations) of usage times permitted for the printer 1. In addition, the lifetime of the printer 1 may be an estimated period calculated based on a remaining amount or a consumed amount of a consumable item, or the number of times the printer 1 has been used. Furthermore, the lifetime of the printer 1 may be determined based on experimental data or predicted from operational data collected from other printers 1 by a server. The lifetime of the printer 1 may also be updated at a particular timing.

In the first illustrative embodiment, after the contract guidance screen 45 is displayed once on the display 68 when the remaining lifetime of the printer 1 is equal to or less than the first period, the contract guidance screen 45 is not displayed again until the printer 1 fails. This configuration makes it possible to reduce the user's sense of annoyance.

In the first illustrative embodiment, when the printer 1 has failed, the contract guidance screen 49 is displayed on the display 68. This configuration makes it possible to prompt the user to enter into the warranty contract when, due to the failure of the printer 1, the user's willingness to enter into the warranty contract is relatively high.

In the first illustrative embodiment, after the contract guidance screen 49 is displayed once on the display 68 when the printer 1 has failed, the contract guidance screen 49 is not displayed again. This configuration makes it possible to reduce the user's sense of annoyance.

In contrast, as will be described later in a second illustrative embodiment according to aspects of the present disclosure, when the remaining lifetime of a replacement component of the printer 1 is short, or when such a component has failed, the user's willingness to enter into the warranty contract may be lower than when the remaining lifetime of the printer 1 is short or when the printer 1 itself has failed. Accordingly, in the first illustrative embodiment, when the remaining lifetime of the printer 1 is short, the contract guidance screen 45 is displayed on the display 68. In addition, when the printer 1 has failed, the contract guidance screen 49 is displayed on the display 68. On the other hand, when the remaining lifetime of a replacement component is short or such a component has failed, no contract guidance screen is displayed. This configuration makes it possible to display the contract guidance screens 45 and 49 when the user's willingness to enter into the warranty contract is relatively high, and to inhibit such contract guidance screens from being displayed when the user's willingness is low, thereby reducing the user's sense of annoyance.

In the first illustrative embodiment, when the warranty contract has not been executed, the contract guidance screen 45 is displayed on the display 68 if the remaining lifetime of the printer 1 is equal to or less than the first period. In addition, when the warranty contract has not been executed, the contract guidance screen 49 is displayed on the display 68 if the printer 1 fails. This configuration makes it possible to prompt the user to enter into the warranty contract when the user's willingness is relatively high. On the other hand, when the warranty contract has been executed, neither the contract guidance screen 45 nor 49 is unnecessarily displayed on the display 68, even if the remaining lifetime of the printer 1 is equal to or less than the first period, or even if the printer 1 fails.

In the first illustrative embodiment, when the warranty contract has been executed, the warranty notification screen 47 is displayed on the display 68 if the remaining lifetime of the printer 1 is equal to or less than the first period. In addition, when the warranty contract has been executed, the warranty notification screen 50 is displayed on the display 68 if the printer 1 fails. This configuration makes it possible to inform the user that, based on the warranty contract, the user is allowed to receive a replacement printer free of charge if the printer 1 fails.

In the first illustrative embodiment, after the remaining lifetime of the printer 1 becomes equal to or less than the first period and the contract guidance screen 45 is displayed on the display 68, or after the printer 1 fails and the contract guidance screen 49 is displayed on the display 68, the controller 80 displays the contract selection screen 46 on the display 68 in response to the selection of the selection section 45B or 49B. If the selection section 46B is then selected on the contract selection screen 46—indicating that the user has chosen to enter into the warranty contract—the controller 80 displays the warranty notification screen 47 or 50 on the display 68, thereby informing the user that a replacement printer is provided free of charge based on the warranty contract. On the other hand, if the selection section 46C is selected on the contract—selection screen 46—indicating that the user has chosen not to enter into the warranty contract the controller 80 displays the purchase guidance screen 48 or 51 on the display 68, thereby prompting the user to purchase a new printer 1.

In the first illustrative embodiment, when the warranty contract has not been executed and the printer 1 has not received the contract completion signal, the contract guidance screen 45 is displayed on the display 68 if the remaining lifetime of the printer 1 is equal to or less than the first period. When the warranty contract has not been executed and the printer 1 has not received the contract completion signal, the contract guidance screen 49 is displayed on the display 68 if the printer 1 fails. This configuration makes it possible to prompt the user to enter into the warranty contract when the user's willingness is relatively high. On the other hand, when the warranty contract has been executed and the printer 1 has received the contract completion signal, neither the contract guidance screen 45 nor 49 is unnecessarily displayed on the display 68, even if the remaining lifetime of the printer 1 is equal to or less than the first period, or even if the printer 1 fails.

In the first illustrative embodiment, the warranty contract is a subscription contract under which a particular fee is paid for each particular period. Therefore, the user is allowed to continuously receive warranty coverage under the warranty contract, including free replacement of the printer 1 when the printer 1 has failed.

### Second Illustrative Embodiment

Next, a second illustrative embodiment according to aspects of the present disclosure will be described. The second illustrative embodiment also relates to a printer 1 configured in substantially the same manner as in the aforementioned first illustrative embodiment. In the second illustrative embodiment as well, the controller 80 is configured to perform processing in accordance with the flowcharts shown in FIGS. 3 and 4A to prompt the user to enter into the warranty contract based on the remaining lifetime of the printer 1. However, in the second illustrative embodiment, the controller 80 is further configured to perform processing to prompt the user to enter into the warranty contract based on the remaining lifetime of a replacement component of the printer 1.

Here, feasible examples of the replacement components for the printer 1 may include the conveyance rollers 6 and 7, the waste liquid tank 33, and consumables such as the ink cartridges 24. In the second illustrative embodiment, the warranty contract includes a warranty that provides coverage not only for free replacement of the printer 1 when the printer 1 has failed, as in the aforementioned first illustrative embodiment, but also for free replacement of a replaceable component when it has failed. Failure of a replacement component refers to, for instance, the conveyance rollers 6 and 7 becoming worn and unable to properly convey the recording sheet S, the waste liquid tank 33 becoming full, or the remaining amount of ink in an ink cartridge 24 falling below a lower limit necessary to supply the inkjet head 4.

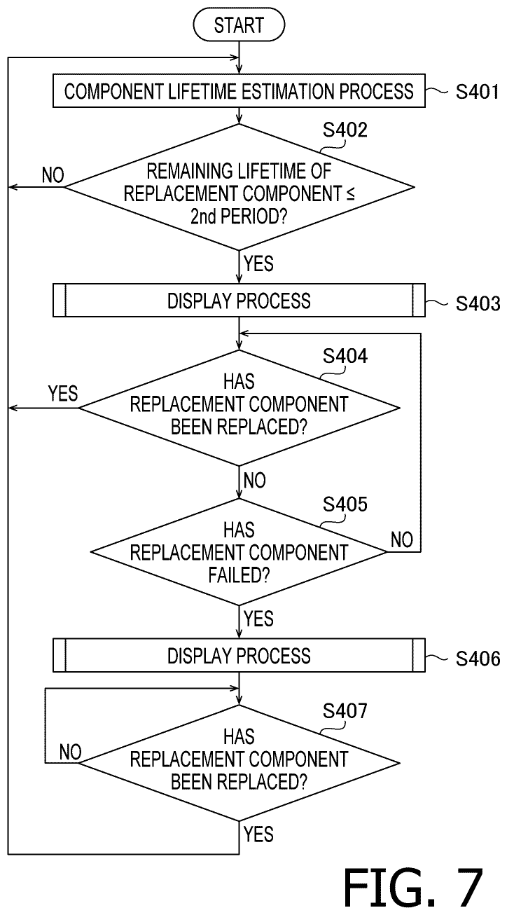

In the second illustrative embodiment, the controller 80 is configured to perform processing in accordance with the flowchart illustrated in FIG. 7 for each replacement component of the printer 1, thereby prompting the user to enter into the warranty contract based on the remaining lifetime of each replacement component. For instance, when power is first supplied to the printer 1, the controller 80 starts the processing in accordance with the flowchart of FIG. 7.

The flowchart in FIG. 7 will be described in detail. The controller 80 performs a component lifetime estimation process (S401). In the component lifetime estimation process of S401, the controller 80 estimates the remaining lifetime of a replacement component based on, for instance, signals from sensors (not shown) of the printer 1, the elapsed time since the replacement component was installed, the number of pages printed since the replacement component was installed, and the number of suction purge operations performed since the replacement component was installed.

Subsequently, the controller 80 determines whether the remaining lifetime of the replacement component estimated in S401 is equal to or less than a second period (S402). The second period may be the same as or different from the first period. Feasible examples of conditions in which the remaining lifetime of the replacement component is equal to or less than the second period may include the conveyance rollers 6 and 7 being worn by a particular amount or more, the amount of waste liquid in the waste liquid tank 33 being equal to or more than a particular liquid level, or the remaining amount of ink in an ink cartridge 24 being equal to or less than a particular ink level.

In response to determining that the remaining lifetime of the replacement component is longer than the second period (S402: No), the controller 80 returns to S401. In response to determining that the remaining lifetime of the replacement component is equal to or less than the second period (S402: YES), the controller 80 proceeds to S403 to perform a display process. In substantially the same manner as in S103, the controller 80 performs the display process of S403 in accordance with the flowchart illustrated in FIG. 4A.

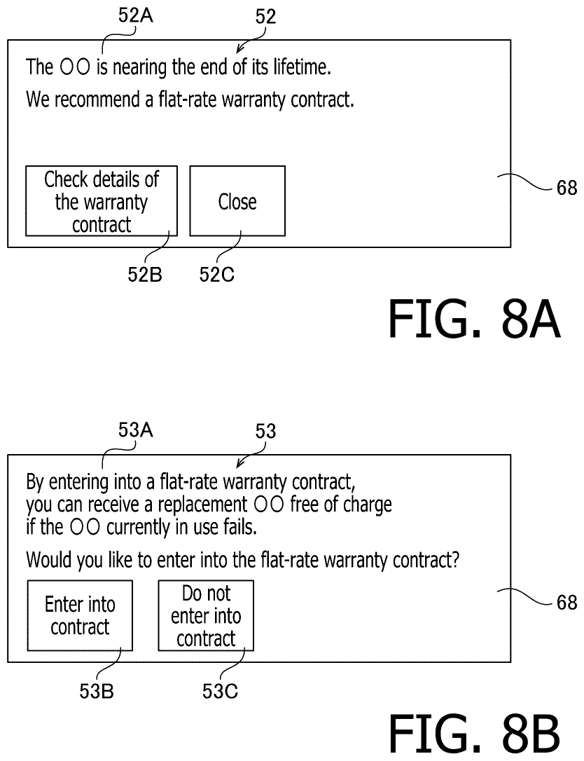

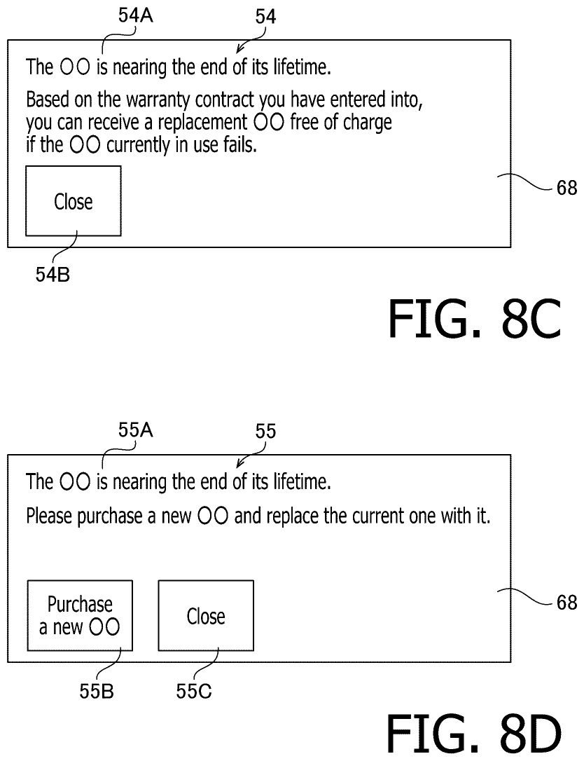

However, in the display process of S403, in the contract guidance screen display process of S202, the controller 80 displays, for instance, a contract guidance screen 52 as illustrated in FIG. 8A on the display 68. Accordingly, in the second illustrative embodiment, when the printer 1 has not received the contract completion signal, the contract guidance screen 52 is displayed on the display 68 if the remaining lifetime of the replacement component is equal to or less than the second period. On the other hand, in substantially the same manner as in the display process of S103, in the display process of S403 as well, after the printer 1 has received the contract completion signal, the contract guidance screen 52 is not displayed on the display 68, even if the remaining lifetime of the replacement component is equal to or less than the second period.

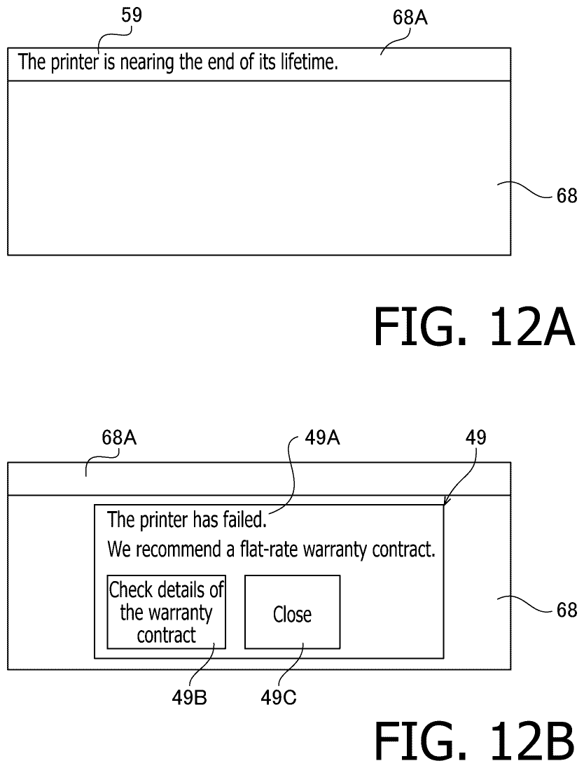

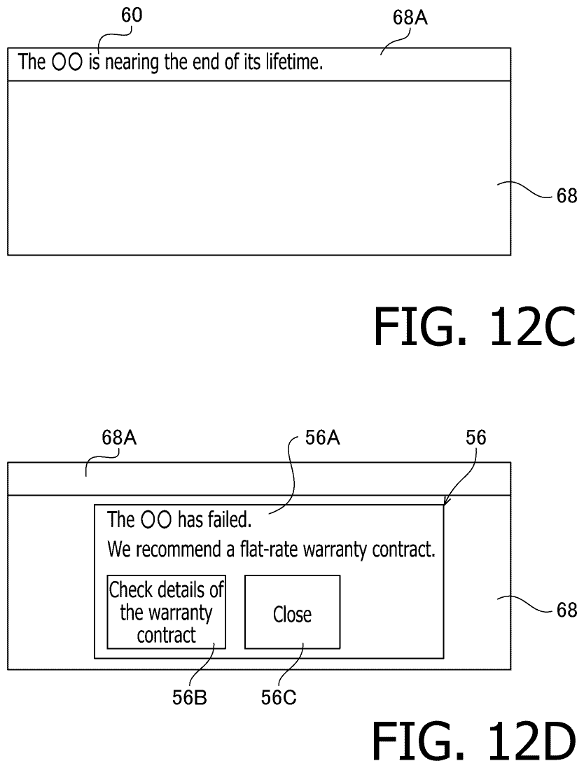

The contract guidance screen 52 shown in FIG. 8A includes a message section 52A and selection sections 52B and 52C. The message section 52A displays a message notifying the user that the replacement component is nearing the end of its lifetime, and a message prompting the user to enter into the warranty contract. The selection sections 52B and 52C are configured in substantially the same manner as the selection sections 45B and 45C on the contract guidance screen 45 shown in FIG. 5A, respectively. It is noted that “oo” in FIG. 8A indicates a name of the replacement component whose remaining lifetime has been estimated in S401. The same applies to “oo” appearing in FIGS. 8B to 8D and FIGS. 12C and 12D to be described later.

In the contract selection screen display process of S205 in the display process of S403, the controller 80 displays, for instance, a contract selection screen 53 as illustrated in FIG. 8B on the display 68. The contract selection screen 53 shown in FIG. 8B includes a message section 53A and selection sections 53B and 53C. The message section 53A displays a message informing the user that executing the warranty contract allows the user to receive a replacement component free of charge if the replacement component currently in use fails, and a message inquiring whether the user wishes to enter into the warranty contract. The selection sections 53B and 53C are configured in substantially the same manner as the selection sections 46B and 46C on the contract selection screen 46 shown in FIG. 5B, respectively.

In the warranty notification screen display process of S208 in the display process of S403, the controller 80 displays, for instance, a warranty notification screen 54 as illustrated in FIG. 8C on the display 68. The warranty notification screen 54 shown in FIG. 8C includes a message section 54A and a selection section 54B. The message section 54A displays a message indicating that the replacement component is nearing the end of its lifetime, and that, based on the warranty contract, the user is allowed to receive a replacement component free of charge if the replacement component currently in use fails. The selection section 54B is configured in substantially the same manner as the selection section 47B on the warranty notification screen 47 shown in FIG. 5C.

In the purchase guidance screen display process of S209 in the display process of S403, the controller 80 displays, for instance, a purchase guidance screen 55 as illustrated in FIG. 8D on the display 68. The purchase guidance screen 55 shown in FIG. 8D includes a message section 55A and selection sections 55B and 55C. The message section 55A displays a message notifying the user that the replacement component is nearing the end of its lifetime, and a message prompting the user to purchase a new replacement component.

The selection section 55B is selected when the user wishes to purchase a replacement component. When the selection section 55B is selected, for instance, a purchase screen (not shown) for purchasing the replacement component is displayed on the display 68. Based on the purchase screen, the user is allowed to purchase the replacement component. The selection section 55C is configured in substantially the same manner as the selection section 48C on the purchase guidance screen 48 shown in FIG. 5D.

Referring back to FIG. 7, after the display process of S403, the controller 80 determines whether the replacement component has been replaced (S404) and whether the replacement component has failed (S405). The determinations in S404 and S405 may be made based on, for instance, signals from sensors (not shown) of the printer 1.

The controller 80 waits until either the replacement component is replaced or the replacement component fails (S404: NO, S405: NO). Accordingly, after the contract guidance screen 52 is displayed once on the display 68 in S202 in the display process of S403, the contract guidance screen 52 is not displayed again until the replacement component fails.

In response to determining that the replacement component has been replaced (S404: YES), the controller 80 returns to S401. In response to determining that the replacement component has failed (S405: YES), the controller 80 proceeds to S406 to perform a display process. In substantially the same manner as in S403, the controller 80 performs the display process of S406 in accordance with the flowchart illustrated in FIG. 4A.

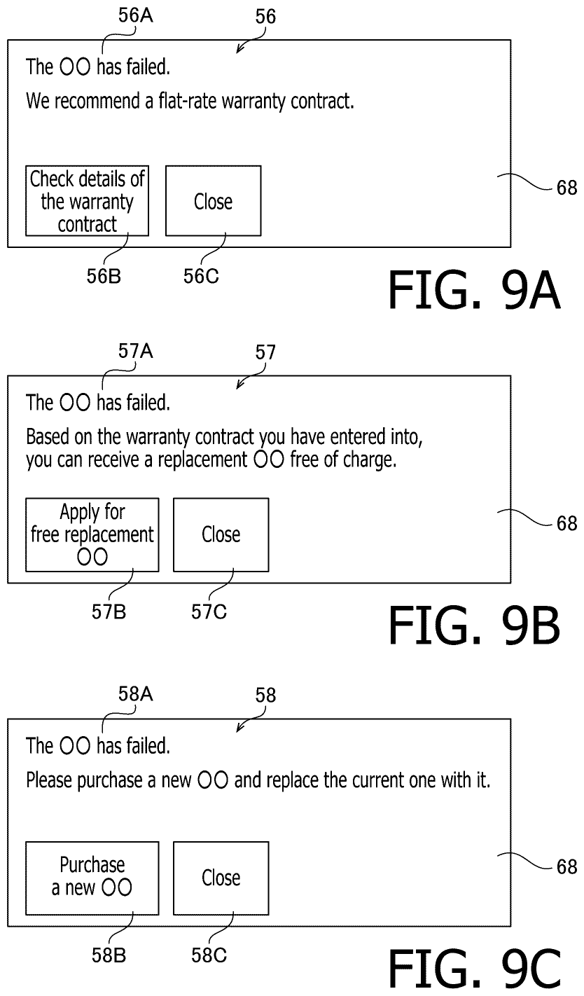

However, in the contract guidance screen display process of S202 in the display process of S406, the controller 80 displays, for instance, a contract guidance screen 56 as illustrated in FIG. 9A on the display 68. Accordingly, in the second illustrative embodiment, when the printer 1 has not received the contract completion signal, the contract guidance screen 56 is displayed on the display 68 if the replacement component fails. On the other hand, in substantially the same manner as in the display process of S403, in the display process of S406 as well, after the printer 1 has received the contract completion signal, the contract guidance screen 56 is not displayed on the display 68 even if the replacement component fails.

The contract guidance screen 56 shown in FIG. 9A includes a message section 56A and selection sections 56B and 56C. The message section 56A displays a message notifying the user that the replacement component has failed, and a message prompting the user to enter into the warranty contract. The selection sections 56B and 56C are configured in substantially the same manner as the selection sections 45B and 45C of the contract guidance screen 45 shown in FIG. 5A, respectively.

In the contract selection screen display process of S205 in the display process of S406, the controller 80 displays, for instance, a contract selection screen 53 as illustrated in FIG. 8B on the display 68, in substantially the same manner as in the display process of S403.

In the warranty notification screen display process of S208 in the display process of S406, the controller 80 displays, for instance, a warranty notification screen 57 as illustrated in FIG. 9B on the display 68. The warranty notification screen 57 shown in FIG. 9B includes a message section 57A and selection sections 57B and 57C. The message section 57A displays a message indicating that the replacement component has failed and that, based on the warranty contract, the user is allowed to receive a replacement component free of charge. The selection section 57B is operated to apply for a free replacement component based on the warranty contract. When the selection section 57B is selected, for instance, an application screen (not shown) for applying for the free replacement component is displayed on the display 68. Based on the application screen, the user is allowed to perform a procedure to apply for the free replacement component. The selection section 57C is configured in substantially the same manner as the selection section 50C on the warranty notification screen 50 shown in FIG. 6B.

In the purchase guidance screen display process of S209 in the display process of S406, the controller 80 displays, for instance, a purchase guidance screen 58 as illustrated in FIG. 9C on the display 68. The purchase guidance screen 58 shown in FIG. 9C includes a message section 58A and selection sections 58B and 58C. The message section 58A displays a message notifying the user that the replacement component has failed, and a message prompting the user to purchase a replacement component. The selection sections 58B and 58C are configured in substantially the same manner as the selection sections 55B and 55C on the purchase guidance screen 55 shown in FIG. 8D, respectively.

Referring back to FIG. 7, after the display process of S406, the controller 80 waits until the replacement component is replaced (S407: NO). In response to determining that the replacement component has been replaced (S407: YES), the controller 80 returns to S401.

In the second illustrative embodiment, the following conditions may be included among examples of a “particular condition” according to aspects of the present disclosure—(1) where the remaining lifetime of the printer 1 is equal to or less than the first period, (2) where the printer 1 has failed, (3) where the remaining lifetime of a replacement component is equal to or less than the second period, and (4) where the replacement component has failed.

### Advantageous Effects

In the second illustrative embodiment, when the remaining lifetime of a replacement component is equal to or less than the second period, the contract guidance screen 52 is displayed on the display 68. This configuration makes it possible to prompt the user to enter into the warranty contract when the remaining lifetime of the replacement component is short and the user's willingness to enter into the warranty contract is relatively high.

In the second illustrative embodiment, after the contract guidance screen 52 is displayed once on the display 68 when the remaining lifetime of a replacement component becomes equal to or less than the second period, the contract guidance screen 52 is not displayed again until the replacement component fails. This configuration makes it possible to reduce the user's sense of annoyance. Additionally, in the second illustrative embodiment, when the replacement component has failed, the contract guidance screen 56 is displayed on the display 68. This configuration makes it possible to prompt the user to enter into the warranty contract when the replacement component has failed and the user's willingness to enter into the warranty contract is relatively high.

In the second illustrative embodiment, after the contract guidance screen 56 is displayed once on the display 68 when a replacement component has failed, the contract guidance screen 56 is not displayed again. This configuration makes it possible to reduce the user's sense of annoyance.

In the second illustrative embodiment, depending on whether the printer 1 or a replacement component currently in use has failed, the user is allowed to receive a replacement printer 1 or a replacement component free of charge based on the warranty contract.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential modifications according to aspects of the present disclosure are provided below.

### Modification

Although the first and second illustrative embodiments according to aspects of the present disclosure have been described above, applicable examples of the present disclosure are not limited to these embodiments, and various modifications are possible within the scope of the claimed concepts to be described.

In the aforementioned first and second illustrative embodiments, when the printer 1 receives the contract completion signal from the server 99, the contract status information stored in the memory 84 is updated from indicating that the warranty contract has not been executed to indicating that the warranty contract has been executed. In S201, the controller 80 acquires the contract status information stored in the memory 84 and determines whether the warranty contract has been executed based on the acquired contract status information. However, applicable examples of the present disclosure are not limited to this configuration.

For instance, after the user enters into the warranty contract through an external device separate from the printer 1, such as a PC or a smartphone, or via a written document, the contract status information stored in the memory 84 may be updated from indicating that the warranty contract has not been executed to indicating that the warranty contract has been executed, when the user has input warranty contract information, such as a contract ID, by operating the operation I/F 69.

In another instance, the server 99 may store contract status information indicating whether the warranty contract has been executed. In this case, in S201, the controller 80 may read the contract status information from the server 99 and determine whether the warranty contract has been executed based on the read contract status information.

In the first and second illustrative embodiments, when each of the aforementioned possible particular conditions is satisfied in a state where the warranty contract has been executed, a corresponding one of the warranty notification screens 47, 50, 54, and 57 is displayed on the display 68. Additionally, when each of the aforementioned possible particular conditions is satisfied in a state where the warranty contract has not been executed, a corresponding one of the contract guidance screens 45, 49, 52, and 56 is displayed on the display 68. Thereafter, when the selection section 45B, 49B, 52B, or 56B is selected on the contract guidance screen 45, 49, 52, or 56, a corresponding one of the contract selection screens 46 and 53 is displayed on the display 68. Then, when the selection section 46B or 53B is selected on the contract selection screen 46 or 53, and the warranty contract is executed accordingly, the warranty notification screen 47 or 50 is displayed on the display 68. On the other hand, when the user has chosen not to enter into the warranty contract by selecting the selection section 46C or 53C, an appropriate one of the purchase guidance screens 48, 51, 55, and 58 is displayed on the display 68. However, applicable examples of the present disclosure are not limited to this configuration.

For instance, when the user has chosen not to enter into the warranty contract by selecting the selection section 46C or 53C on the contract selection screen 46 or 53, none of the purchase guidance screens 48, 51, 55, and 58 may be displayed, and the display of the contract selection screens 46 or 53 on the display 68 may be terminated. Additionally, when the selection section 46B or 53B is selected on the contract selection screen 46 or 53, and the warranty contract is executed accordingly, none of the warranty notification screens 47, 50, 54, and 57 may be displayed, and the display of the contract selection screen 46 or 53 on the display 68 may be terminated.

In another instance, none of the warranty notification screens 47, 50, 54, and 57 may be displayed on the display 68, even if one of the aforementioned possible particular conditions is satisfied in the state where the warranty contract has been executed.

In yet another instance, when one of the aforementioned possible particular conditions is satisfied, a corresponding one of the contract guidance screens 45, 49, 52, and 56 may be displayed on the display 68, regardless of whether the warranty contract has been executed.

Further, the contract guidance screen and the contract selection screen may not necessarily be separate screens. For instance, the contract guidance screens 45 and 49 may further include, in the message sections 45A and 49A, the same messages as in the message section 46A on the contract selection screen 46. Additionally, the contract guidance screens 52 and 56 may further include, in the message sections 52A and 56A, the same messages as in the message section 53A on the contract selection screen 53. Then, instead of including the selection section 45B or 49B, each of the contract guidance screens 45 and 49 may include the same selection sections as the selection sections 46B and 46C on the contract selection screen 46. Additionally, instead of including the selection section 52B or 56B, each of the contract guidance screens 52 and 56 may include the same selection sections as the selection sections 53B and 53C on the contract selection screen 53. That is, the printer 1 may be configured to receive a user selection as to whether to enter into the warranty contract directly via a contract guidance screen, without transitioning to a separate contract selection screen.

In the aforementioned first and second illustrative embodiments, after the contract guidance screen 45 is displayed only once on the display 68 when the remaining lifetime of the printer 1 is equal to or less than the first period, the contract guidance screen 45 is not displayed again until the printer 1 fails. However, applicable examples of the present disclosure are not limited to this configuration. For instance, after the remaining lifetime of the printer 1 has become equal to or less than the first period, the display process of S103 may be repeated at regular time intervals until the printer 1 fails, and the contract guidance screen 45 may be displayed on the display 68 two or more times. In this case, the contract guidance screen 45 may be displayed a particular number of times not less than two, and then no longer displayed until the printer 1 fails. In another instance, the contract guidance screen 45 may be displayed without any limitation on the number of times until the printer 1 fails.

In the aforementioned first illustrative embodiment, after the contract guidance screen 49 is displayed only once on the display 68 when the printer 1 has failed, the contract guidance screen 49 is not displayed again. However, applicable examples of the present disclosure are not limited to this configuration. For instance, after the printer 1 has failed, the display process of S105 may be repeated at regular time intervals, and the contract guidance screen 49 may be displayed on the display 68 two or more times. In this case, the contract guidance screen 49 may be displayed a particular number of times not less than two, and then no longer displayed. In another instance, the contract guidance screen 49 may be displayed without any limitation on the number of times.

In the aforementioned first illustrative embodiment, a corresponding one of the contract guidance screens 45 and 49 is displayed on the display 68 in each of the following cases—(1) where the remaining lifetime of the printer 1 is equal to or less than the first period, and (2) where the printer 1 has failed. However, applicable examples of the present disclosure are not limited to this configuration. The contract guidance screen may be displayed on the display 68 in only one of these cases.

In the aforementioned second illustrative embodiment, after the contract guidance screen 52 is displayed only once on the display 68 when the remaining lifetime of a replacement component is equal to or less than the second period, the contract guidance screen 52 is not displayed again until the replacement component fails. However, applicable examples of the present disclosure are not limited to this configuration. For instance, after the remaining lifetime of the replacement component has become equal to or less than the second period, the display process of S403 may be repeated at regular time intervals until the replacement component fails, and the contract guidance screen 52 may be displayed on the display 68 two or more times. In this case, the contract guidance screen 52 may be displayed a particular number of times not less than two, and then no longer displayed until the replacement component fails. In another instance, the contract guidance screen 52 may be displayed without any limitation on the number of times until the replacement component fails. Here, from the time the remaining lifetime of one replacement component has become equal to or less than the second period until that component fails, the remaining lifetime of another replacement component may become equal to or less than the second period. In such a case, the contract guidance screen 52 may be displayed individually for each failed component. That is, the flowchart illustrated in FIG. 7 may be executed for each replacement component.

In the aforementioned second illustrative embodiment, after the contract guidance screen 56 is displayed only once on the display 68 when a replacement component has failed, the contract guidance screen 56 is not displayed again. However, applicable examples of the present disclosure are not limited to this configuration. For instance, after the replacement component has failed, the display process of S406 may be repeated at regular time intervals, and the contract guidance screen 56 may be displayed on the display 68 two or more times. In this case, the contract guidance screen 56 may be displayed a particular number of times not less than two, and then no longer displayed. In another instance, the contract guidance screen 56 may be displayed without any limitation on the number of times.

In the aforementioned second illustrative embodiment, a corresponding one of the contract guidance screens 45, 49, 52, and 56 is displayed on the display 68 in each of the following cases—(1) where the remaining lifetime of the printer 1 is equal to or less than the first period, (2) where the printer 1 has failed, (3) where the remaining lifetime of a replacement component is equal to or less than the second period, and (4) where the replacement component has failed. However, applicable examples of the present disclosure are not limited to this configuration. The contract guidance screen may be displayed on the display 68 in only some (i.e., at least one but not all) of these cases.

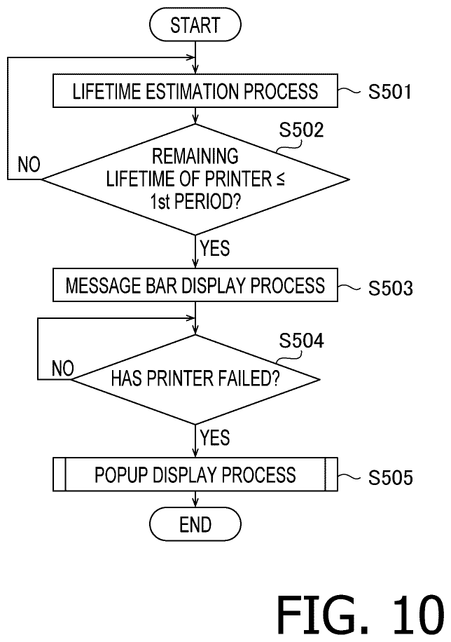

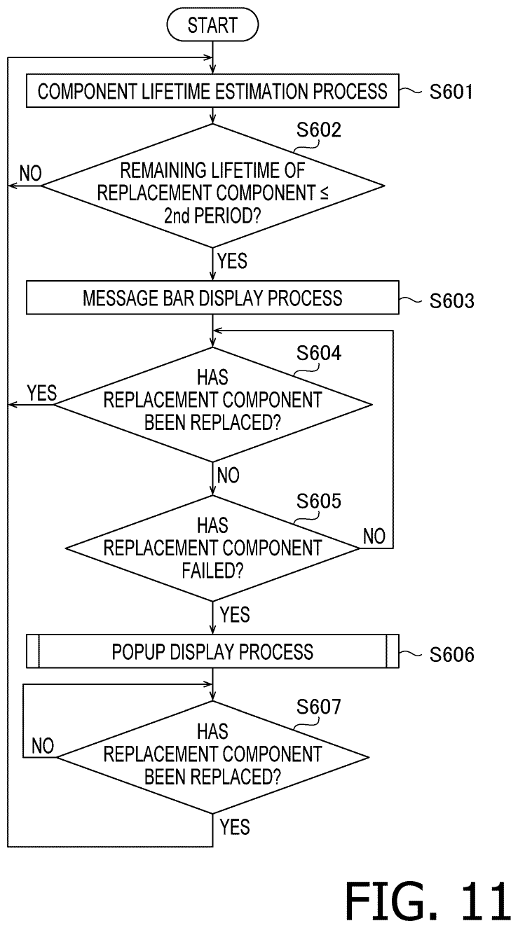

In the aforementioned first and second illustrative embodiments, each screen is displayed over the entire area of the display 68. However, applicable examples of the present disclosure are not limited to this configuration. In a first modification according to aspects of the present disclosure, the controller 80 is configured to perform processing, in accordance with the flowchart illustrated in FIG. 10, to prompt the user to enter into the warranty contract based on the remaining lifetime of the printer 1. Additionally, in the first modification, the controller 80 is further configured to perform processing, in accordance with the flowchart illustrated in FIG. 11, to prompt the user to enter into the warranty contract based on the remaining lifetime of a replacement component.

In the flowchart of FIG. 10, the controller 80 executes S501 and S502, which are substantially the same as S101 and S102, respectively. In response to determining in S502 that the remaining lifetime of the printer 1 is equal to or less than the first period (S502: YES), the controller 80 proceeds to S503 to perform a message bar display process.

In the first modification, as illustrated in FIGS. 12A to 12D, a message bar 68A extending in a horizontal direction is provided at an upper end portion of the display 68. Nonetheless, the message bar 68A may instead be provided at a lower end portion of the display 68. In the message bar display process of S503, the controller 80 displays a message 59 on the message bar 68A, as illustrated in FIG. 12A, to notify the user that the printer 1 is nearing the end of its lifetime.

Referring back to FIG. 10, after the message bar display process of S503, the controller 80 proceeds to S504 to determine whether the printer 1 has failed, in substantially the same manner as in S104, and waits until the printer 1 fails (S504: NO). In response to determining that the printer 1 has failed (S504: YES), the controller 80 proceeds to S505 to perform a popup display process. Thereafter, the controller 80 terminates the process illustrated in FIG. 10.

In the popup display process of S505, the controller 80 performs processing in accordance with the flowchart illustrated in FIG. 4A, in substantially the same manner as the display process of S103. However, in the popup display process of S505, unlike in the display process of S103, the controller 80 displays each screen as a popup on the display 68 in S202, S205, S208, and S209. FIG. 12B shows an example of a state in which the contract guidance screen 49 is displayed as a popup on the display 68.

Next, the flowchart illustrated in FIG. 11 will be described. In the flowchart of FIG. 11, the controller 80 executes S601 and S602, which are substantially the same as S401 and S402, respectively. In response to determining in S602 that the remaining lifetime of a replacement component is equal to or less than the second period (S602: YES), the controller 80 proceeds to S603 to perform a message bar display process.

In the message bar display process of S603, as illustrated in FIG. 12C, the controller 80 displays, on the message bar 68A, a message 60 notifying the user that the replacement component is nearing the end of its lifetime.

Referring back to FIG. 11, after the message bar display process of S603, the controller 80 waits until the replacement component is replaced or fails (S604: NO, S605: NO). In response to determining that the replacement component has been replaced (S604: YES), the controller 80 returns to S601. In response to determining that the replacement component has failed (S605: YES), the controller 80 proceeds to S606 to perform a popup display process.

In the popup display process of S606, the controller 80 performs processing in accordance with the flowchart illustrated in FIG. 4A, in substantially the same manner as in the display process of S105. However, in the popup display process of S606, unlike in the display process of S105, the controller 80 displays each screen as a popup on the display 68 in S202, S205, S208, and S209. FIG. 12D illustrates an example in which the contract guidance screen 56 is displayed as a popup on the display 68.

After the popup display process of S606, the controller 80 waits until the replacement component is replaced (S607: NO). In response to determining in S607 that the replacement component has been replaced (S607: YES), the controller 80 returns to S601.

In the first modification, the condition in which the printer 1 has failed and the condition in which a replacement component has failed may be included among examples of the “particular conditions” according to aspects of the present disclosure.

The printer 1 in the first modification is configured to notify the user that the printer 1 or a replacement component is nearing the end of its lifetime, by displaying the message 59 or the message 60 on the message bar 68A. The printer 1 in the first modification is further configured to display the contract guidance screen 49 or the contract guidance screen 56 as a popup on the display 68 when the printer 1 or the replacement component has failed, thereby prompting the user to enter into the warranty contract when the user's willingness is relatively high.

Hereinabove, examples have been described in which the contract guidance screens are displayed on the display 68 of the printer 1. However, applicable examples of the present disclosure are not limited to these.

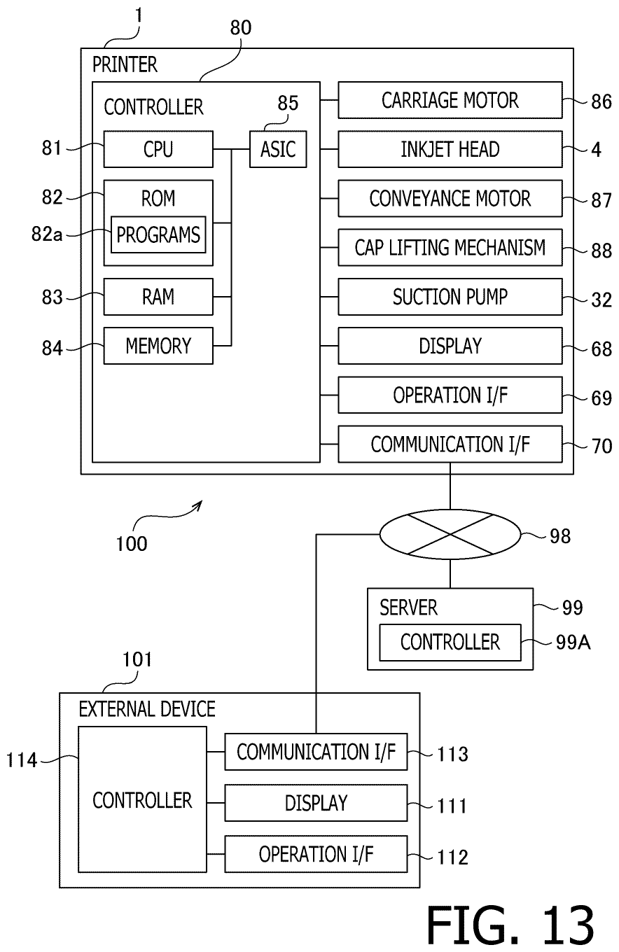

In a second modification according to aspects of the present disclosure, as illustrated in FIG. 13, the system 100 includes an external device 101, in addition to the printer 1 and the server 99, which are the same as those in the system 40 of the aforementioned first illustrative embodiment.

Feasible examples of the external device 101 may include, but are not limited to, a PC and a smartphone. The external device 101 includes a display 111, an operation I/F 112, a communication I/F 113, and a controller 114. Feasible examples of the display 111 may include, but are not limited to, a liquid crystal display. The operation I/F 112 may include a keyboard and/or a mouse if the external device 101 is a PC. The operation I/F 112 may include a touch panel if the external device 101 is a smartphone. The communication I/F 113 is connected to the network 98 and is communicably connected to the communication I/F 70 of the printer 1 via the network 98.

The controller 114 includes a CPU, a ROM, a RAM, and a memory. The controller 114 is configured to control the display 111 and the communication I/F 113. The controller 114 is further configured to receive signals input through the operation I/F 112 and the communication I/F 113.

In the system 100 of the second modification, the controller 80 of the printer 1 performs processing in accordance with the flowcharts shown in FIGS. 3 and 4A, in substantially the same manner as in the aforementioned first illustrative embodiment, or in accordance with the flowcharts shown in FIGS. 3, 4A, and 7, in substantially the same manner as in the aforementioned second illustrative embodiment.

However, in the second modification, in S202, S205, S208, and S209, the controller 80 of the printer 1 transmits, via the communication I/F 70 and the network 98, signals to the external device 101 instructing it to display the corresponding screens. In response to receiving these signals via the communication I/F 113, the controller 114 of the external device 101 displays the corresponding screens on the display 111. That is, in the second modification, the external device 101 displays each screen on its display 111 under the control of the controller 80 of the printer 1.

In the second modification, when the aforementioned particular conditions are satisfied, the controller 80 of the printer 1 causes the display 111 of the external device 101 to display the contract guidance screens. This configuration makes it possible to prompt the user to enter into the warranty contract when the user's willingness is relatively high.

In the second modification, each screen is displayed on the display 111 of the external device 101 under the control of the controller 80 of the printer 1. However, applicable examples of the present disclosure are not limited to this configuration. In a third modification according to aspects of the present disclosure, in substantially the same manner as in the second modification, the system 100 includes the printer 1, the server 99, and the external device 101, which are communicably interconnected via the network 98, as illustrated in FIG. 13.

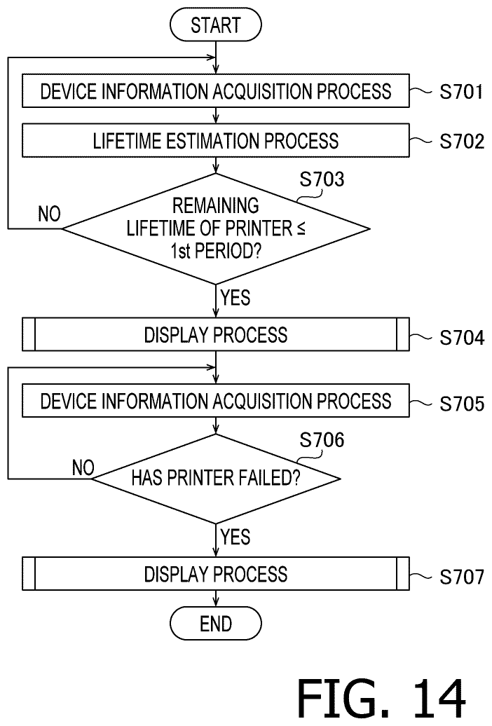

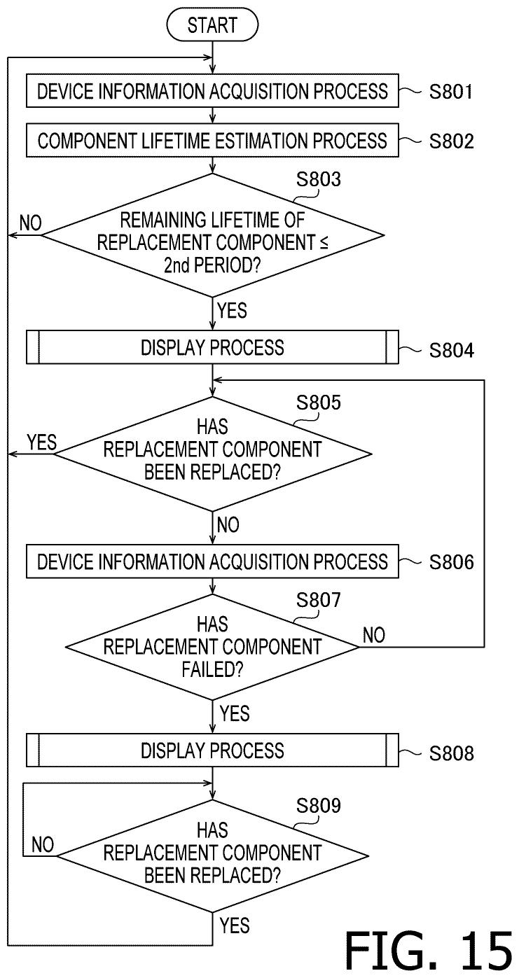

In the third modification, the controller 99A of the server 99 performs processing to prompt the user to enter into the warranty contract based on the remaining lifetime of the printer 1, in accordance with the flowchart illustrated in FIG. 14. Further, the controller 99A performs processing for each replacement component in accordance with the flowchart illustrated in FIG. 15, thereby prompting the user to enter into the warranty contract based on the remaining lifetime of each replacement component.

In the flowchart of FIG. 14, the controller 99A of the server 99 first performs a device information acquisition process (S701). Specifically, in S701, the controller 99A acquires, from the printer 1, device information necessary to estimate the remaining lifetime of the printer 1. The device information includes, for instance, signals from sensors (not shown) of the printer 1, the elapsed time since the printer 1 was first activated, and the total number of pages printed by the printer 1.

Subsequently, the controller 99A of the server 99 performs a lifetime estimation process (S702). Specifically, in S702, the controller 99A estimates the remaining lifetime of the printer 1 based on the device information acquired in S701.

Next, the controller 99A of the server 99 determines whether the remaining lifetime of the printer 1 estimated in S702 is equal to or less than the first period (S703). In response to determining that the remaining lifetime of the printer 1 is longer than the first period (S703: NO), the controller 99A returns to S701.

In response to determining that the remaining lifetime of the printer 1 is equal to or less than the first period (S703: YES), the controller 99A of the server 99 proceeds to S704 to perform a display process. In the display process of S704, the controller 99A performs processing in accordance with the flowchart illustrated in FIG. 4A. However, in S202, S205, S208, and S209 of the display process executed in S704, the controller 99A transmits, to the external device 101, signals to instruct the external device 101 to display the corresponding screens. In response to receiving these signals, the controller 114 of the external device 101 displays the corresponding screens on the display 111.

After the display process of S704, the controller 99A of the server 99 performs a device information acquisition process (S705), in substantially the same manner as in S701. Subsequently, the controller 99A determines whether the printer 1 has failed, based on the device information acquired in S705 (S706). In response to determining that the printer 1 has not failed (S706: NO), the controller 99A returns to S705. In response to determining that the printer 1 has failed (S706: YES), the controller 99A proceeds to S707 to perform a display process, in substantially the same manner as in S704. Thereafter, the controller 99A terminates the process illustrated in FIG. 14.

In the flowchart of FIG. 15, the controller 99A of the server 99 first performs a device information acquisition process (S801). Specifically, in S801, the controller 99A acquires, from the printer 1, device information necessary to estimate the remaining lifetime of a replacement component. The device information includes, for instance, signals from sensors (not shown) of the printer 1, the elapsed time since a previous replacement component was replaced with the replacement component currently in use, the number of pages printed since the replacement, and the number of suction purges performed since the replacement.

Subsequently, the controller 99A of the server 99 performs a component lifetime estimation process (S802). Specifically, in S802, the controller 99A estimates the remaining lifetime of the replacement component based on the device information acquired in S801.

Next, the controller 99A of the server 99 determines whether the remaining lifetime of the replacement component estimated in S802 is equal to or less than the second period (S803). In response to determining that the remaining lifetime of the replacement component is longer than the second period (S803: NO), the controller 99A returns to S801.

In response to determining that the remaining lifetime of the replacement component is equal to or less than the second period (S803: YES), the controller 99A of the server 99 proceeds to S804 to perform a display process. In the display process of S804, the controller 99A performs processing in accordance with the flowchart illustrated in FIG. 4A. However, in S202, S205, S208, and S209 of the display process executed in S804, the controller 99A transmits signals to the external device 101 to instruct it to display the corresponding screens. In response to receiving these signals, the controller 114 of the external device 101 displays the corresponding screens on the display 111.

After the display process of S804, the controller 99A of the server 99 determines whether the replacement component has been replaced, in substantially the same manner as in S404 (S805). In response to determining that the replacement component has been replaced (S805: YES), the controller 99A returns to S801. In response to determining that the replacement component has not been replaced (S805: NO), the controller 99A proceeds to S806 to perform a device information acquisition process, in substantially the same manner as in S801.

Subsequently, the controller 99A of the server 99 determines whether the replacement component has failed, based on the device information acquired in S806 (S807). In response to determining that the replacement component has not failed (S807: NO), the controller 99A returns to S805. In response to determining that the replacement component has failed (S807: YES), the controller 99A proceeds to S808 to perform a display process, in substantially the same manner as in S804. However, in S202, S208, and S209 of the display process executed in S808, the controller 99A transmits signals to the external device 101 to instruct it to display the corresponding screens. In response to receiving these signals, the controller 114 of the external device 101 displays the corresponding screens on the display 111.

After the display process of S808, the controller 99A of the server 99 waits until the replacement component is replaced (S809: NO). In response to determining that the replacement component has been replaced (S809: YES), the controller 99A returns to S801.

In the third modification, as described above, the controller 99A of the server 99 causes the display 111 of the external device 101 to display each screen.

In the third modification, a corresponding one of the contract guidance screens 45, 49, 52, and 56 is displayed on the display 111 of the external device 101 under the control of the controller 99A of the server 99 in each of the following cases—(1) where the remaining lifetime of the printer 1 is equal to or less than the first period, (2) where the printer 1 has failed, (3) where the remaining lifetime of a replacement component is equal to or less than the second period, and (4) where the replacement component has failed. This configuration makes it possible to prompt the user to enter into the warranty contract when the user's willingness is relatively high.

In the third modification, the controller 99A of the server 99 may perform only one of the respective processes according to the flowcharts of FIGS. 14 and 15.

In the aforementioned examples, cases have been described in which at least one of the following possible particular conditions is applied as the particular condition—(1) where the remaining lifetime of the printer 1 is equal to or less than the first period, (2) where the printer 1 has failed, (3) where the remaining lifetime of a replacement component is equal to or less than the second period, and (4) where a replacement component has failed. However, applicable examples of the present disclosure are not limited to these. The particular condition may be another condition related to the remaining lifetime of the printer 1 or the replacement component.

In addition, the aforementioned examples have been described under the assumption that the printer 1 is kept communicable with the server 99, or with both the server 99 and the external device 101. However, applicable examples of the present disclosure are not limited to these.

A fourth modification according to aspects of the present disclosure will be described below. The fourth modification relates to the system 40 including the printer 1 and the server 99 connected via the network 98, as illustrated in FIG. 2.

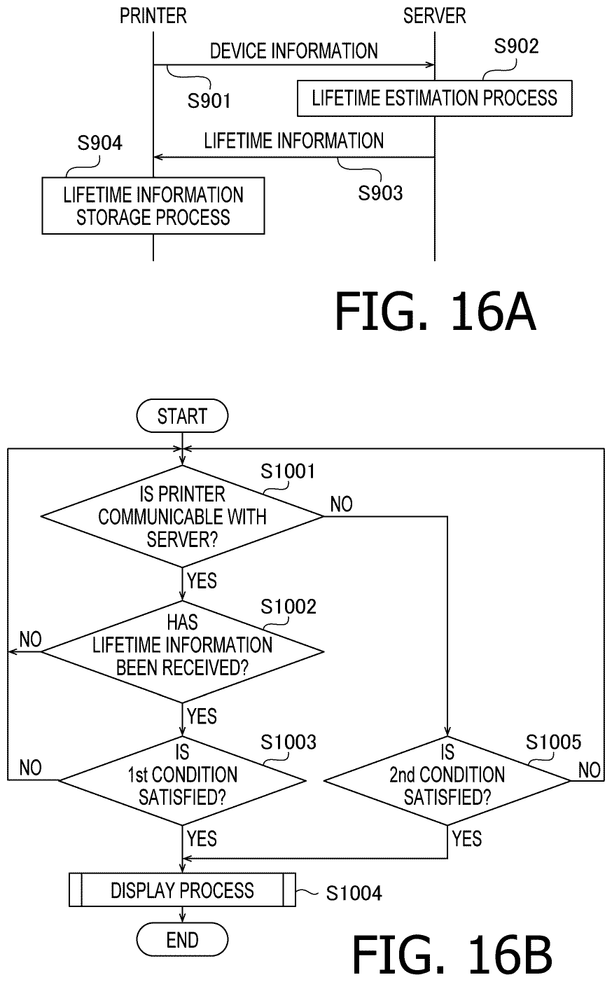

In the fourth modification, while the printer 1 and the server 99 are communicably interconnected, a signal transmission and reception procedure is performed between them at particular time intervals, as illustrated in FIG. 16A. Specifically, the printer 1 transmits device information necessary to estimate the remaining lifetime of the printer 1 to the server 99 (S901). The device information transmitted in S901 may be, for instance, substantially the same type as the device information acquired in S701 in the aforementioned third modification.

When the server 99 has received the device information, the controller 99A of the server 99 performs a lifetime estimation process to estimate the remaining lifetime of the printer 1 based on the received device information (S902). Then, based on the remaining lifetime of the printer 1 estimated in S902, the server 99 transmits lifetime information regarding the remaining lifetime of the printer 1 to the printer 1 (S903). When the printer 1 has received the lifetime information, the controller 80 of the printer 1 performs a lifetime information storage process to store the lifetime information in the memory 84 (S904).

In the fourth modification, the controller 80 of the printer 1 performs processing in accordance with the flowchart illustrated in FIG. 16B, thereby displaying the contract guidance screens based on the remaining lifetime of the printer 1. The controller 80 starts the processing in accordance with the flowchart of FIG. 16B when power is supplied to the printer 1.

Details of the flowchart illustrated in FIG. 16B will be described. The controller 80 of the printer 1 determines whether the printer 1 is communicable with the server 99 (S1001). In response to determining that the printer 1 is communicable with the server 99 (S1001: YES), the controller 80 proceeds to S1002 to determine whether lifetime information has been received from the server 99 (S1002). In response to determining that the lifetime information has not been received (S1002: NO), the controller 80 returns to S1001.

In response to determining that the lifetime information has been received from the server 99 (S1002: YES), the controller 80 of the printer 1 determines whether the remaining lifetime of the printer 1 indicated by the received lifetime information satisfies a first condition (S1003). Here, the first condition may be, for instance, a condition in which the remaining lifetime of the printer 1 is equal to or less than the first period. However, the first condition may be a different condition related to the remaining lifetime of the printer 1.

In response to determining that the first condition is not satisfied (S1003: NO), the controller 80 of the printer 1 returns to S1001. In response to determining that the first condition is satisfied (S1003: YES), the controller 80 proceeds to S1004 to perform a display process. Thereafter, the controller 80 terminates the process illustrated in FIG. 16B.

In the display process of S1004, the controller 80 of the printer 1 performs processing in accordance with the flowchart illustrated in FIG. 4A. However, in S1004, the screens to be displayed in S202, S205, S208, and S209 correspond to the content of the first condition. For instance, if the first condition is that the remaining lifetime of the printer 1 is equal to or less than the first period, then in S202, S205, S208, and S209 of the display process executed in S1004, the controller 80 displays the screens shown in FIGS. 5A to 5D on the display 68, respectively.

On the other hand, in response to determining that the printer 1 is not communicable with the server 99 (S1001: NO), the controller 80 of the printer 1 determines whether the remaining lifetime of the printer 1, indicated by the lifetime information previously stored in the memory 84 during the lifetime information storage process of S904, satisfies a second condition (S1005). The second condition may be the same as or different from the first condition. For instance, the second condition may be that the remaining lifetime of the printer 1, indicated by the stored lifetime information, is equal to or less than a third period that is longer than the first period. In another instance, the second condition may be that the period, obtained by subtracting the elapsed time since the lifetime information was last stored from the remaining lifetime indicated by the stored lifetime information, is equal to or less than the first period.

In response to determining that the second condition is not satisfied (S1005: NO), the controller 80 of the printer 1 returns to S1001. In response to determining that the second condition is satisfied (S1005: YES), the controller 80 proceeds to S1004 to perform a display process (see FIG. 4A). Thereafter, the controller 80 terminates the process illustrated in FIG. 16B.

In the fourth modification, the lifetime information received by the printer 1 is stored in the memory 84. When the printer 1 is communicable with the server 99, the controller 80 of the printer 1 displays the contract guidance screens on the display 68 if the first condition related to the remaining lifetime indicated by the lifetime information received from the server 99 is satisfied. This configuration makes it possible to prompt the user to enter into the warranty contract when the user's willingness is relatively high. When the printer 1 is not communicable with the server 99, the controller 80 displays the contract guidance screens on the display 68 if the second condition related to the lifetime information stored in the memory 84 is satisfied. Accordingly, even when the printer 1 is brought into a state where it is not communicable with the server 99, the printer 1 is enabled to prompt the user to enter into the warranty contract when the user's willingness is relatively high.

In the fourth modification, for instance, an external device such as a PC or a smartphone, other than the server 99, may perform signal transmission and reception with the printer 1, as illustrated in FIG. 16A.

In the aforementioned examples, the warranty contract is a subscription contract under which warranty coverage is maintained by paying a particular fee for each particular period. However, applicable examples of the present disclosure are not limited to this configuration. For instance, the warranty contract may be a contract under which warranty coverage is maintained for a fixed period by paying a fee once, and the warranty ends after the lapse of the fixed period. Further, the particular fee paid for each particular period may vary. In the aforementioned examples, when a condition related to the lifetime of the printer 1 is satisfied, a particular object (e.g., a contract guidance screen), prompting the user to enter into a warranty contract under which a replacement printer 1 is provided free of charge if the printer 1 currently in use fails, is displayed on a display. However, the replacement printer 1 may not necessarily be provided free of charge. For instance, the replacement printer 1 may be provided for a fee that is less than a price originally paid by the user for the current printer 1, or a price to be paid for the same model as the current printer 1. That is, when a condition related to the lifetime of the printer 1 is satisfied, a particular object prompting the user to enter into a warranty contract under which a replacement printer 1 is provided for a fee if the printer 1 currently in use fails may be displayed on a display.

In the aforementioned examples, cases have been described in which the possible replacement components of the printer 1 include the conveyance rollers 6 and 7, the waste liquid tank 33, and the ink cartridges 24. However, applicable examples of the present disclosure are not limited to these. The possible replacement components of the printer 1 may include only some (i.e., at least one but not all) of these components, or may include other components.

In the aforementioned examples, the control device has been described as an inkjet printer configured to eject ink toward a recording sheet S from nozzles. However, applicable examples of the present disclosure are not limited to this configuration. The control device may be another image recording apparatus, such as a laser printer having replacement components such as toner cartridges and conveyance rollers. In such a case, the toner cartridges may be included among the examples of a “consumable item” according to aspects of the present disclosure. Furthermore, the control device may be an electronic apparatus other than an image recording apparatus, such as an image scanner having one or more replacement components, such as a light source unit.

The following provides examples of associations between elements set forth in the aforementioned illustrative embodiment(s) and modification(s), and elements claimed according to aspects of the present disclosure. For instance, the printer 1 may be an example of a “control device” according to aspects of the present disclosure, and it may be an example of an “image recording apparatus” according to aspects of the present disclosure. The display 68 of the printer 1 may be an example of a “display” of the “control device” according to aspects of the present disclosure. The communication I/F 70 of the printer 1 may be an example of a “communication interface” of the “control device” according o aspects of the present disclosure. The controller 80 of the printer 1 may be an example of a “controller” of the “control device” according to aspects of the present disclosure. Feasible replacement components, such as the conveyance rollers 6 and 7 and the waste liquid tank 33, may be included among examples of a “replaceable component” according to aspects of the present disclosure. Further, consumables such as the ink cartridges 24 may also be included among examples of the “replaceable component” according to aspects of the present disclosure. The inkjet head 4 may be an example of a “recording head” according to aspects of the present disclosure. The ink cartridges 24 may be included among examples of a “consumable item” according to aspects of the present disclosure. The recording sheet S may be an example of a “recording medium” according to aspects of the present disclosure. The message bar 68A may be an example of an “information bar” according to aspects of the present disclosure. The CPU 81 included in the controller 80 of the printer 1 may be an example of a “processor” included in the “controller” of the “control device” according to aspects of the present disclosure. The ROM 82 storing the programs 82a, included in the controller 80 of the printer 1, may be an example of a “non-transitory computer-readable storage medium” storing “computer-readable instructions,” included in the “controller” of the “control device,” according to aspects of the present disclosure. In the aforementioned first illustrative embodiment, the contract guidance screens 45 and 49 may be included among examples of a “first object” according to aspects of the present disclosure. In the first illustrative embodiment, the warranty notification screens 47 and 50 may be included among examples of a “second object” according to aspects of the present disclosure. In the first illustrative embodiment, the contract selection screen 46 may be an example of a “third object” according to aspects of the present disclosure. In the first illustrative embodiment, the purchase guidance screens 48 and 51 may be included among examples of a “fourth object” according to aspects of the present disclosure. In the aforementioned second illustrative embodiment, the contract guidance screens 45, 49, 52, and 56 may be included among examples of the “first object” according to aspects of the present disclosure. In the second illustrative embodiment, the warranty notification screens 47, 50, 54, and 57 may be included among examples of the “second object” according to aspects of the present disclosure. In the second illustrative embodiment, the contract selection screens 46 and 53 may be included among examples of the “third object” according to aspects of the present disclosure. In the second illustrative embodiment, the purchase guidance screens 48, 51, 55, and 58 may be included among examples of the “fourth object” according to aspects of the present disclosure. In the aforementioned first modification, the contract guidance screens 49 and 56 displayed as popups may be included among examples of the “first object” according to aspects of the present disclosure. In the first modification, the warranty notification screens 50 and 57 displayed as popups may be included among examples of the “second object” according to aspects of the present disclosure. In the first modification, the contract selection screens 46 and 53 displayed as popups may be included among examples of the “third object” according to aspects of the present disclosure. In the first modification, the purchase guidance screens 51 and 58 displayed as popups may be included among examples of the “fourth object” according to aspects of the present disclosure. In the first modification, the messages 59 and 60 displayed on the message bar 68A may be included among examples of a “particular object” according to aspects of the present disclosure. In the aforementioned second modification, the external device 101 may be an example of an “external device” according to aspects of the present disclosure. In the second modification, the display 111 of the external device 101 may be an example of a “display” of the “external device” according to aspects of the present disclosure. In the second modification, the contract guidance screens 45, 49, 52, and 56 may be included among examples of an “object” according to aspects of the present disclosure. In the aforementioned third modification, the external device 101 may be an example of an “information processing device” according to aspects of the present disclosure. In the third modification, the display 111 of the external device 101 may be an example of a “display” of the “information processing device” according to aspects of the present disclosure. In the third modification, the server 99 may be an example of a “server” according to aspects of the present disclosure. In the third modification, the controller 99A of the server 99 may be an example of a “controller” of the “server” according to aspects of the present disclosure. In the third modification, the contract guidance screens 45, 49, 52, and 56 may be included among examples of the “object” according to aspects of the present disclosure. In the aforementioned fourth modification, the server 99 may be an example of an “information processing device” according to aspects of the present disclosure. In the fourth modification, the controller 80 of the printer 1 may be an example of a “first controller” according to aspects of the present disclosure. In the fourth modification, the controller 99A of the server 99 may be an example of a “second controller” according to aspects of the present disclosure. In the fourth modification, the memory 84 of the printer 1 may be an example of a “memory” according to aspects of the present disclosure. In the fourth modification, the contract guidance screens may be included among examples of an “object” according to aspects of the present disclosure.

What is claimed is:

1. A control device comprising:
a display; and
a controller configured to cause the display to display a first object for prompting execution of a warranty contract under which another control device is provided in response to a failure of the control device, when a particular condition related to a lifetime of the control device is satisfied.

2. The control device according to claim 1,
wherein the controller is further configured to cause the display to display the first object for prompting execution of the warranty contract under which a replacement control device is provided free of charge in response to the failure of the control device, when the particular condition is satisfied.

3. The control device according to claim 1,
wherein the controller is further configured to cause the display to display the first object for prompting execution of the warranty contract under which a replacement control device is provided for a fee in response to the failure of the control device, when the particular condition is satisfied.

4. The control device according to claim 1,
wherein the particular condition includes a condition in which a remaining lifetime of the control device is equal to or less than a first period.

5. The control device according to claim 4,
wherein the controller is further configured to cause the display to display the first object when the condition in which the remaining lifetime of the control device is equal to or less than the first period is satisfied, and thereafter to inhibit the display from displaying the first object on the display until the control device fails.

6. The control device according to claim 1,
wherein the particular condition includes a condition in which the control device has failed.

7. The control device according to claim 6,
wherein the controller is further configured to cause the display to display the first object when the condition in which the control device has failed is satisfied, and thereafter to inhibit the display from displaying the first object.

8. The control device according to claim 1, further comprising a replaceable component,
wherein the particular condition includes a condition in which a remaining lifetime of the replaceable component is equal to or less than a second period.

9. The control device according to claim 8,
wherein the controller is further configured to cause the display to display the first object when the condition in which the remaining lifetime of the replaceable component is equal to or less than the second period is satisfied, and thereafter to inhibit the display from displaying the first object until the replaceable component fails.

10. The control device according to claim 1, further comprising a replaceable component,
wherein the particular condition includes a condition in which the replaceable component has failed.

11. The control device according to claim 10,
wherein the controller is further configured to cause the display to display the first object when the condition in which the replaceable component has failed is satisfied, and thereafter to inhibit the display from displaying the first object.

12. The control device according to claim 2, further comprising a replaceable component,
wherein the particular condition includes either a first condition in which a remaining lifetime of the control device is equal to or less than a first period or a second condition in which the control device has failed, and includes neither a third condition in which a remaining lifetime of the replaceable component is equal to or less than a second period nor a fourth condition in which the replaceable component has failed.

13. The control device according to claim 2, further comprising a recording head configured to record an image on a recording medium using a consumable item.

14. The control device according to claim 2,
wherein the controller is further configured to:
acquire contract status information indicating whether the warranty contract has been executed;
in a state where the acquired contract status information indicates that the warranty contract has not been executed, cause the display to display the first object when the particular condition is satisfied; and
in a state where the acquired contract status information indicates that the warranty contract has been executed, inhibit the display from displaying the first object even when the particular condition is satisfied.

15. The control device according to claim 14,
wherein the controller is further configured to:
in the state where the acquired contract status information indicates that the warranty contract has been executed, cause the display to display a second object indicating that a replacement control device is provided free of charge based on the warranty contract, when the particular condition is satisfied.

16. The control device according to claim 15,
wherein the controller is further configured to:
after displaying the first object, cause the display to display a third object for prompting selection of whether to execute the warranty contract;
cause the display to display the second object in response to receiving a signal indicating selection to execute the warranty contract; and
cause the display to display a fourth object for prompting purchase of a new control device in response to receiving a signal indicating selection not to execute the warranty contract.

17. The control device according to claim 14, communicably connected to a server,
wherein the controller is further configured to:
transmit, to the server, a contract execution signal indicating that the warranty contract is to be executed, when the control device is communicable with the server;
receive, from the server, a contract completion signal indicating that the warranty contract has been executed, thereby acquiring the contract status information indicating that the contract has been executed;
cause the display to display the first object, when the particular condition is satisfied in a state where the contract completion signal has not been received from the server; and
inhibit the display from displaying the first object, when the particular condition is satisfied after the contract completion signal has been received from the server.

18. The control device according to claim 2,
wherein the display includes an information bar configured to display information,
wherein the particular condition includes either a condition in which the control device has failed or a condition in which a replaceable component included in the control device has failed, and
wherein the controller is further configured to:
cause the display to display, on the information bar, a particular object indicating that a remaining lifetime of the control device or the replaceable component is short, when the remaining lifetime of the control device is equal to or less than a first period or when the remaining lifetime of the replaceable component is equal to or less than a second period; and
cause the display to display the first object as a popup when the particular condition is satisfied.

19. The control device according to claim 2, further comprising a replaceable component,
wherein the warranty contract includes a warranty that provides coverage under which the replaceable component is provided free of charge in response to a failure of the replaceable component.

20. The control device according to claim 2,
wherein the warranty contract is a subscription contract under which a particular fee is paid for each particular period.

21. The control device according to claim 1,
wherein the controller comprises:
a processor; and
a non-transitory computer-readable storage medium storing computer-readable instructions configured to, when executed by the processor, cause the controller to display the first object on the display when the particular condition is satisfied.

22. A control device comprising:
a communication interface configured to communicably connect to an external device comprising a display; and
a controller configured to cause the display of the external device to display an object for prompting execution of a warranty contract under which another control device is provided in response to a failure of the control device, when a particular condition related to a lifetime of the control device is satisfied, while the control device is communicable with the external device via the communication interface.

23. The control device according to claim 22,
wherein the controller is further configured to cause the display of the external device to display the first object for prompting execution of the warranty contract under which a replacement control device is provided free of charge in response to the failure of the control device, when the particular condition is satisfied, while the control device is communicable with the external device via the communication interface.

24. The control device according to claim 22,
wherein the controller is further configured to cause the display of the external device to display the first object for prompting execution of the warranty contract under which a replacement control device is provided for a fee in response to the failure of the control device, when the particular condition is satisfied, while the control device is communicable with the external device via the communication interface.

25. A system comprising:
a control device;
an information processing device comprising a display, the information processing device being communicably connected to the control device; and
a server communicably connected to the control device, the server comprising a controller configured to:
acquire lifetime information regarding a lifetime of the control device; and
when the acquired lifetime information indicates that a particular condition related to the lifetime of the control device is satisfied, cause the display of the information processing device to display an object for prompting execution of a warranty contract under which another control device is provided in response to a failure of the control device.

26. The system according to claim 25,
wherein the controller of the server is further configured to:
acquire, from the control device, the lifetime information regarding the lifetime of the control device; and
when the acquired lifetime information indicates that the particular condition related to the lifetime of the control device is satisfied, cause the display of the information processing device to display the object for prompting execution of the warranty contract under which a replacement control device is provided free of charge in response to the failure of the control device.

27. The system according to claim 25,
wherein the controller of the server is further configured to:
acquire, from the control device, the lifetime information regarding the lifetime of the control device; and
when the acquired lifetime information indicates that the particular condition related to the lifetime of the control device is satisfied, cause the display of the information processing device to display the object for prompting execution of the warranty contract under which a replacement control device is provided for a fee in response to the failure of the control device.

28. A system comprising:
a control device comprising a display, a memory, and a first controller; and
an information processing device communicably connected to the control device, the information processing device comprising a second controller configured to:
acquire device information regarding the control device;
estimate a remaining lifetime of the control device based on the acquired device information; and
transmit, to the control device, lifetime information regarding the estimated remaining lifetime of the control device,
wherein the first controller of the control device is configured to:
receive the lifetime information from the information processing device and store the received lifetime information in the memory;
in a state where the control device is communicable with the information processing device, cause the display to display an object for prompting execution of a warranty contract under which another control device is provided in response to a failure of the control device, when a first condition related to the remaining lifetime indicated by the lifetime information received from the information processing device is satisfied; and
in a state where the control device is not communicable with the information processing device, cause the display to display the object, when a second condition related to the remaining lifetime indicated by the lifetime information stored in the memory is satisfied.

29. The system according to claim 28,
wherein the first controller of the control device is further configured to:
in the state where the control device is communicable with the information processing device, cause the display to display the object for prompting execution of the warranty contract under which a replacement control device is provided free of charge in response to the failure of the control device, when the first condition related to the remaining lifetime indicated by the lifetime information received from the information processing device is satisfied; and
in the state where the control device is not communicable with the information processing device, cause the display to display the object when the second condition related to the remaining lifetime indicated by the lifetime information stored in the memory is satisfied.

30. The system according to claim 28,
wherein the first controller of the control device is further configured to:
in the state where the control device is communicable with the information processing device, cause the display to display the object for prompting execution of the warranty contract under which a replacement control device is provided for a fee in response to the failure of the control device, when the first condition related to the remaining lifetime indicated by the lifetime information received from the information processing device is satisfied; and
in the state where the control device is not communicable with the information processing device, cause the display to display the object when the second condition related to the remaining lifetime indicated by the lifetime information stored in the memory is satisfied.
